(19) United States
(12) Patent Application Publication
(10) Pub. No.: US 2025/0159117 A1
(43) Pub. Date: May 15, 2025

(54) IMAGE OUTPUT DEVICE

(71) Applicant: SAMSUNG ELECTRONICS CO., LTD., Suwon-si (KR)

(72) Inventors: Sanghoon EUM, Suwon-si (KR); Giseok SUNG, Suwon-si (KR); Gohwoon JEONG, Suwon-si (KR); Dosung JUNG, Suwon-si (KR)

(73) Assignee: SAMSUNG ELECTRONICS CO., LTD., Suwon-si (KR)

(21) Appl. No.: 19/025,065

(22) Filed: Jan. 16, 2025

Related U.S. Application Data
(63) Continuation of application No. PCT/KR2023/010113, filed on Jul. 14, 2023.

(30) Foreign Application Priority Data
Sep. 1, 2022 (KR) 10-2022-0111044

(51) Int. Cl. H04N 9/31; G03B 21/14

(52) U.S. Cl. CPC H04N 9/3141; G03B 21/145

(57) ABSTRACT

A video output device includes a projector module configured to output a content image along a radiation direction, a first rotating device configured to rotate at least a portion of the projector module about a first axis that is parallel to the radiation direction, a second rotating device configured to rotate the projector module about a second axis intersecting the first axis, a substrate electrically connected to the second rotating device, and a connector electrically connected to the substrate through a first wire, electrically connected to the second rotating device through a second wire. While the projector module rotates about the second axis, the connector is configured to prevent the first wire and the second wire from being twisted.

### CROSS-REFERENCE TO RELATED APPLICATION

This application is a continuation application is a continuation application, under 35 U.S.C. § 111 (a), of international application No PCT/KR2023/010113, filed Jul. 14, 2023, which claims priority under 35 U. S. C. § 119 to Korean Patent Application No. 10-2022-0111044, filed Sep. 1, 2022, the disclosures of which are incorporated herein by reference in their entireties.

### TECHNICAL FIELD

The present disclosure relates to a video output device, and more particularly, to a video output device capable of changing an output direction of video.

### BACKGROUND ART

A projector is a type of video display device that projects image information onto an external screen.

The projector is equipped with an illumination system and a projection system to provide separate image data in the form of films, etc. so that users could view desired data by replacing it. However, recently, a projector includes an imaging system using a display module and connects to a computer or video player to display desired screens. In this case, images are implemented on the imaging system, that is, the display module by image information provided from a device, such as a computer, a video player, etc., the illumination system provides appropriate light to the display module that itself cannot generate light although implementing images, the light is transmitted through the display module to form projected images, and the formed projected images are enlarged by being transmitted through the projection system to be projected onto a screen placed at an appropriate distance.

Nowadays, projectors are becoming smaller and lighter and portable projectors are becoming commercialized as small display devices such as transmissive Liquid Crystal Display (LCD) or Digital Micro Device (DMD) are used. These portable projectors are useful for office workers who frequently travel outside the office and attend meetings.

In order to set the projection direction of such a projector to a user's desired direction, the projector needs to be able to adjust the projection direction.

While the projector rotates to the projection direction, wires may become twisted. The twisted wires may cause short circuits or the like, and such risks should be prevented.

### DISCLOSURE

### Technical Problem

An aspect of the present disclosure provides a video output device capable of moving freely.

An aspect of the present disclosure provides a video output device capable of rotating without twisting of wires.

### Technical Solution

To solve the problem, a video output device according to a concept of the present disclosure may include a projector module configured to output a content image along a radiation direction, a first rotating device configured to rotate at least a portion of the projector module about a first axis that is parallel to the radiation direction, a second rotating device configured to rotate the projector module about a second axis intersecting the first axis, a substrate electrically connected to the second rotating device, and a connector electrically connected to the substrate through a first wire, electrically connected to the second rotating device through a second wire, wherein, while the projector module rotates about the second axis, the connector may be configured to prevent the first wire and the second wire from being twisted.

The video output device may further include a third rotating device configured to rotate the projector module about a third axis intersecting the first axis and the second axis.

The first rotating device may be configured to rotate the at least the portion of the projector module in a first rotation direction or in an opposite direction of the first rotation direction without limitation, the second rotating device may be configured to rotate the projector module in a second rotation direction or in an opposite direction of the second rotation direction without limitation, and the third rotating device may be configured to rotate the projector module in a third rotation direction or in an opposite direction of the third rotation direction without limitation.

The video output device may further include a first part housing coupled to the projector module and a second part housing rotatably coupled to the first part housing, and the second rotating device may rotate the projector module about the second axis by rotating the first part housing relative to the second part housing.

The second part housing may include a support plate configured to rotatably support the first part housing, and a cover housing configured to accommodate the support plate and at least a portion of the first part housing and be rotatable together with the support plate.

The second rotating device may include a motor, a first gear being rotatable by the motor, and a second gear engaged with the first gear, configured to rotate about the second axis as a rotation axis, and coupled to the second part housing.

The motor may be spaced from the second axis to orbit around the second axis while the first part housing rotates, and the connector may be configured to prevent the second wire connected to the motor from moving and maintain an electrical connection.

The substrate may be accommodated in the second part housing and the connector may be configured to prevent the first wire connected to the substrate from being twisted and maintain an electrical connection.

The connector may include a fixed body including an accommodating groove capable of accommodating the second wire connected to the second rotating device and a terminal configured to contact the first wire in the accommodating groove, the fixed body being coupled to the first part housing, and the terminal may rotate about the second axis together with the projector module and maintain contact with the first wire while the projector module rotates about the second axis.

The connector may include a fixed body configured to be coupled to the first part housing, and a rotating body connected to the first wire connected to the substrate and configured to be coupled to the fixed body in such a way as to rotate relative to the fixed body, and the rotating body may be configured to allow the first wire to rotate about the second axis as a rotation axis while the projector module rotates about the second axis.

The first part housing may include a seating plate configured such that the motor is located on one side of the seating plate and the substrate faces another side of the seating plate which is opposite to the one side, and a rotating housing coupled to the seating plate and configured to rotate together with the seating plate, wherein the connector may penetrate the seating plate.

The second part housing may include a support plate configured to face the seating plate, the second gear may be coupled to the support plate between the support plate and the seating plate, and the second rotating device may include a bearing positioned between the second gear and the seating plate and configured to be rotatable relative to the second gear.

The projector module may include a first part spinning housing, and a second part spinning housing rotatably coupled to the first part spinning housing, and the first rotating device may include a spinning motor coupled to the first part spinning housing, a first spinning gear configured to be rotatable by the spinning motor, and a second spinning gear engaged with the first spinning gear, coupled to the first part spinning housing, and configured to rotate the second part spinning housing about the first axis while the first spinning gear rotates.

The third rotating device may include a tilting motor configured to be supported by the support plate, a first pulley coupled to the tiling motor and configured to be rotated by the tiling motor, a second pulley coupled to the projector module, and a rail coupled to the first pulley and the second pulley and configured such that the projector module rotates according to a rotation of the first pulley.

The video output device may include a power terminal configured to receive power from an external source and located on the second part housing, and a third wire configured to connect the power terminal to the motor and connected to the connector.

A video output device according to a concept of the present disclosure may include a projector module, a first rotating device configured to rotate at least a portion of the projector module about a first axis, a second rotating device configured to rotate the projector module about a second axis intersecting the first axis, a third rotating device configured to rotate the projector module about a third axis intersecting the first axis and the second axis, a substrate electrically connected to the second rotating device, a first wire connected to the substrate, a second wire connected to the second rotating device, and a connector connected to the first wire and the second wire, wherein the connector may include a fixed body including an accommodating groove capable of accommodating the second wire connected to the second rotating device and a terminal configured to contact the first wire in the accommodating groove, and a rotating body connected to the first wire connected to the substrate and configured to be coupleable to the fixed body in such a way as to rotate relative to the fixed body, the rotating body may be configured to allow the first wire to rotate about the second axis while the projector module rotates about the second axis, and the terminal may rotate about the second axis together with the projector module and maintain contact with the first wire while the projector module rotates about the second axis.

The video output device may further include a first part housing coupleable to the projector module, and a second part housing rotatably coupleable to the first part housing, and the second rotating device may rotate the projector module about the second axis by rotating the first part housing relative to the second part housing.

The second rotating device may include a motor including a rotation shaft, a first gear configured to rotate while the rotation shaft rotates, and a second gear engaged with the first gear, configured to rotate about the second axis as a rotation axis, and coupleable to the second part housing.

The third rotating device may include a tilting motor coupleable to the first part housing, a first pulley coupleable to the tiling motor and configured to be rotated by the tiling motor, a second pulley coupleable to the projector module, and a rail coupleable to the first pulley and the second pulley and configured such that the projector module rotates according to a rotation of the first pulley.

A video output device according to a concept of the present disclosure may include a projector module configured to radiate a content image in a radiation direction, a rotating device configured to rotate the projector module about an axis that is perpendicular to a floor surface, a substrate electrically connected to the rotating device, and a connector electrically connected to the substrate through a first wire, electrically connected to the rotating device through a second wire, and configured to prevent the first wire and the second wire from being twisted while the projector module rotates.

### Advantageous Effects

According to a concept of the disclosure based on the technical solution, a video output device may move freely by rotating about each of a first axis, a second axis intersecting the first axis, and a third axis intersecting the first axis and the second axis.

According to a concept of the disclosure, a video output device may rotate without twisting of wires by including a connector for preventing the wires from being twisted.

### DESCRIPTION OF DRAWINGS

FIG. 1 is a perspective view of a video output device according to an embodiment of the present disclosure.

FIG. 2 is a conceptual diagram of the video output device shown in FIG. 1 according to an embodiment of the present disclosure.

FIG. 3 is a top view showing inside of a projector module of the video output device shown in FIG. 1 according to an embodiment of the present disclosure.

FIG. 4 is an exploded view of the video output device shown in FIG. 1 according to an embodiment of the present disclosure.

FIG. 5 is an exploded view of a second part housing and a part of internal components in the video output device shown in FIG. 4 according to an embodiment of the present disclosure.

FIG. 6 is a cross-sectional view of the video output device shown in FIG. 1 according to an embodiment of the present disclosure.

FIG. 7 is an exploded view of the second part housing and a part of internal components in the video output device shown in FIG. 4 according to an embodiment of the present disclosure.

FIG. 8 is a cross-sectional perspective view of the video output device shown in FIG. 1 according to an embodiment of the present disclosure.

FIG. 9 is a cross-sectional view of the video output device shown in FIG. 1 according to an embodiment of the present disclosure.

FIG. 10 is a cross-sectional view of the video output device shown in FIG. 1 according to an embodiment of the present disclosure.

FIG. 11 is a perspective view showing a projector module of the video output device shown in FIG. 1 according to an embodiment of the present disclosure.

FIG. 12 is a perspective view showing the video output device shown in FIG. 1 according to an embodiment of the present disclosure.

FIG. 13 is a cross-sectional view of a video output device according to an

embodiment of the present disclosure.

FIG. 14 is a perspective view of a video output device according to an embodiment of the present disclosure.

FIG. 15 is a control block diagram according to an embodiment of the present disclosure.

FIG. 16 is a control flow diagram for adjusting a projection direction based on storage of a projection direction according to an embodiment of the present disclosure.

FIG. 17 is a control flow diagram for adjusting a projection direction based on detection of a user position according to an embodiment of the present disclosure.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “first”, “second”, or “1st” or “2nd” may be used simply to distinguish a component from other components, without limiting the component in other aspects (e.g., importance or order).

Some (e.g., a first) component is referred to as “coupled” or “connected” with or without the terms “functionally” or “communicatively” to another (e.g., second) component. When mentioned, it means that any of the above components can be connected to the other components directly (e.g., by wire), wirelessly, or via a third component.

It is to be understood that the terms such as “including” or “having,” etc., are intended to indicate the existence of the features, numbers, steps, operations, components, parts, or combinations thereof disclosed in the document, and are not intended to preclude the possibility that one or more other features, numbers, steps, operations, components, parts, or combinations thereof may exist or may be added.

It is to be understood that if a certain component is referred to as being “coupled with,” “coupled to,” “supported on” or “in contact with” another component, it means that the component may be coupled with the other component directly or indirectly via a third component.

It will also be understood that when a certain component is referred to as being “on” or “over” another component, it can be directly on the other component or intervening components may also be present.

Meanwhile, in the following description, the terms “up-down direction”, “lower side”, and “front-rear direction”, etc. are defined based on the drawings, and the shapes and positions of the corresponding components are not limited by these terms.

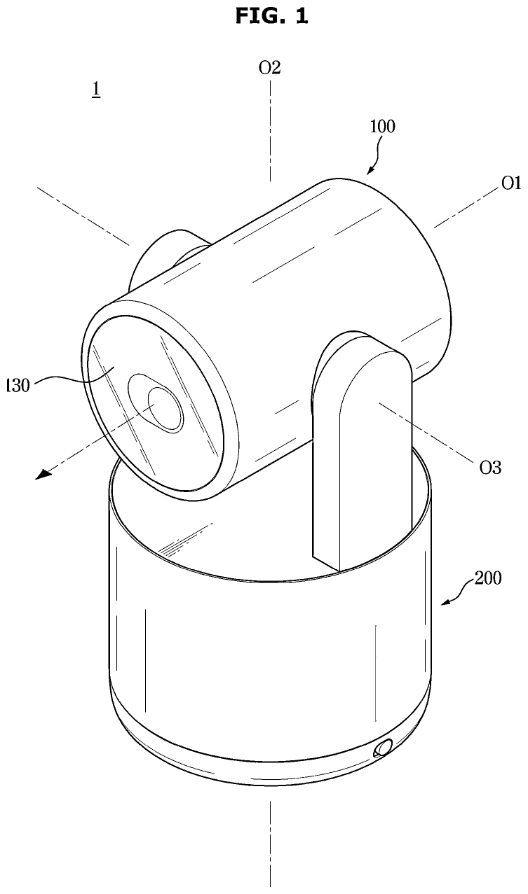

More specifically, as shown in FIG. 1, a radiation direction D which is a direction in which image content of a video output device 1 is radiated may be set to a front direction, and a rear direction, left and right sides, and upper and lower sides may be defined based on the front direction.

Hereinafter, embodiments according to the present disclosure will be described in detail with reference to the accompanying drawings.

FIG. 1 is a perspective view of a video output device 1 according to an embodiment of the present disclosure.

The video output device 1 according to an embodiment of the present disclosure will be described with reference to FIG. 1.

The video output device 1 may be a device for outputting an image.

An image that the video output device 1 outputs may be an image that is output according to a user's intention.

For example, the video output device 1 may be a projector that outputs an image onto a screen with a beam. Alternatively, the video output device 1 may be a display device. In this case, the video output device 1 may include a separate display and output an image onto the display.

However, the following description will be, for convenience of explanation, given under an assumption that the video output device 1 is a projector. However, the video output device 1 is not limited thereto and may be any type capable of outputting an image.

The video output device 1 may include a projector module 100. The projector module 100 may be a component capable of outputting an image.

The projector module 100 may radiate a content image in a radiation direction D.

The projector module 100 may radiate a content image in a radiation direction D.

The projector module 100 may have a cylindrical shape. However, the projector module 100 is not limited thereto and may have various shapes.

The projector module 100 may be rotatable. Accordingly, the projector module 100 may output an image onto a user's desired location. A direction in which the projector module 100 outputs an image is referred to as a radiation direction D.

The projector module 100 may be rotatable about a first axis O1 that is parallel to the radiation direction D. For example, the first axis O1 may be an x axis or an axis extending in a front-rear direction.

A rotation of the projector module 100 about the first axis O1 may be referred to as spinning.

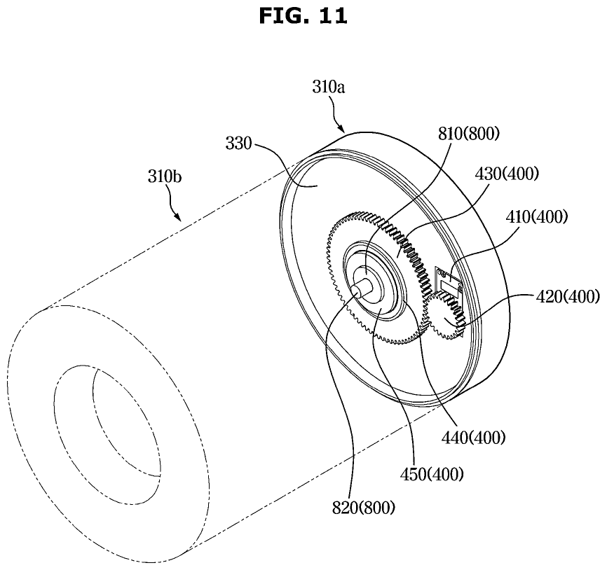

The video output device 1 may include a first rotating device 400 (see FIG. 11) for spinning the projector module 100.

The first rotating device 400 may be configured to rotate at least a portion of the projector module 100 about the first axis O1 that is parallel to the radiation direction D.

The projector module 100 may be rotatable about a second axis O2 intersecting the first axis O1. For example, the second axis O2 may be a z-axis or an axis extending in an up-down direction.

A rotation of the projector module 100 about the second axis O2 may be referred to as panning.

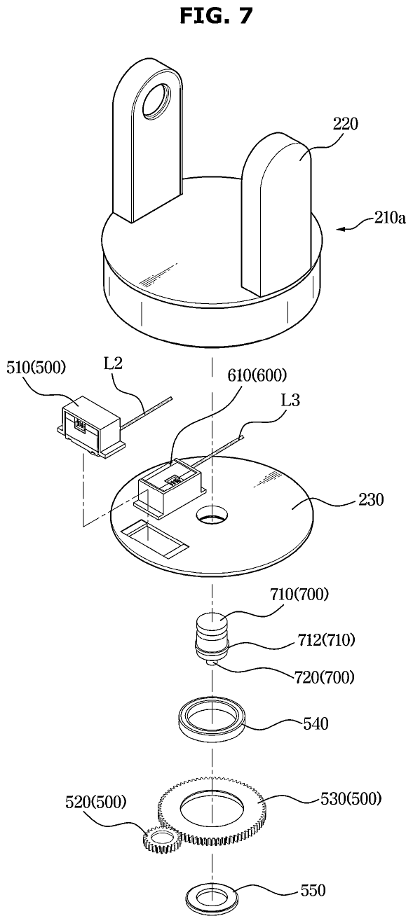

The video output device 1 may include a second rotating device 500 (see FIG. 7) for panning the projector module 100.

The second rotating device 500 may be configured to rotate the projector module 100 about a second axis O2 intersecting the first axis O1.

The projector module 100 may be rotatable about a third axis O3 intersecting the first axis O1 and the second axis O2. For example, the third axis O3 may be a y-axis or an axis extending in a left-right direction.

A rotation of the projector module 100 about the third axis O3 is referred to as tilting.

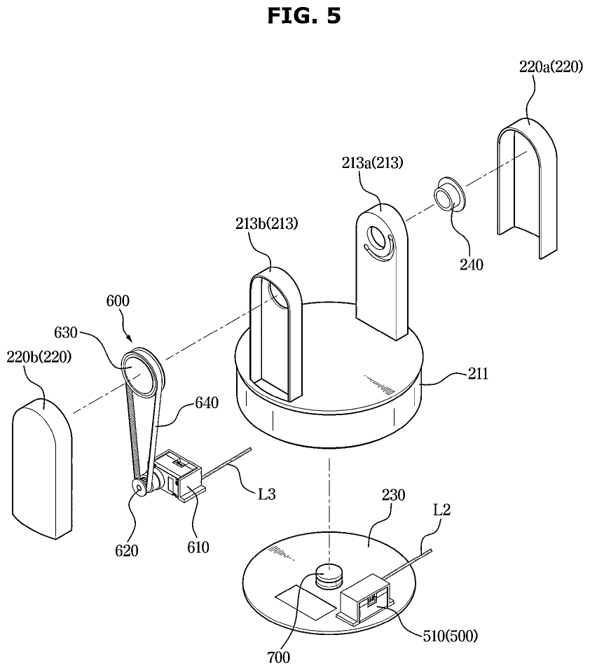

The video output device 1 may include a third rotating device 600 (see FIG. 5) for tilting the projector module 100.

The projector module 100 may output a content image in all directions desired by a user by rotating about the first axis O1, the second axis O2, and the third axis O3. A method by which the projector module 100 moves based on the first axis O1, the second axis O2, and the third axis O3 will be described with reference to the associated drawings, below.

The projector module 100 may include a projection system. The projection system may be a configuration that projects an image.

The projection system may be provided on a front side of the projector module 100. However, the projection system is not limited thereto, and may be provided on any side of the projector module 100.

The video output device 1 may include a housing 200. The housing 200 may be a configuration that defines an appearance of the video output device 1.

The housing 200 may define the appearance of the video output device 1 together with the projector module 100.

The housing 200 may be coupled to the projector module 100. The housing 200 may be rotatably coupled to the projector module 100. The housing 200 may support the projector module 100 in such a way that the projector module 100 is rotatable.

The housing 200 may include a cylindrical shape. The housing 200 may have a height in the vertical direction.

The housing 200 may have a shape that extends toward the projector module 100 and is coupled to the projector module 100, in addition to the cylindrical shape.

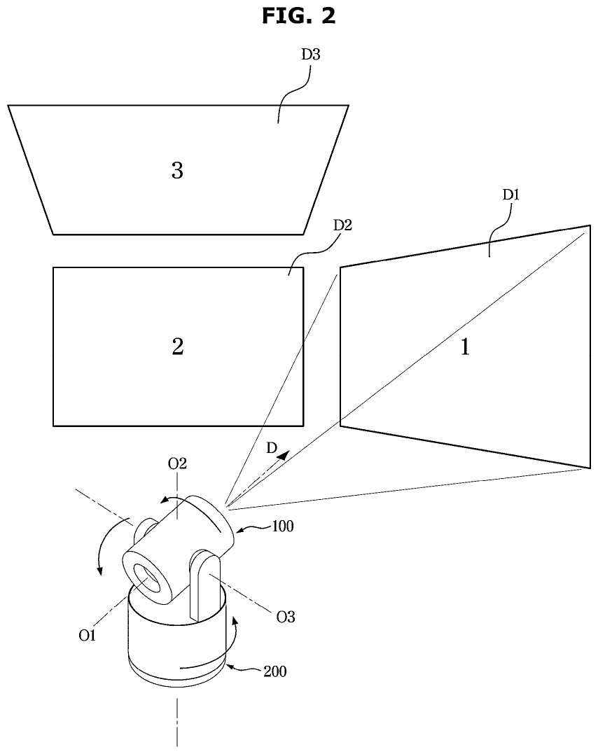

FIG. 2 is a conceptual diagram of the video output device 1 shown in FIG. 1.

A method by which the projector module 100 according to an embodiment of the present disclosure radiates an image in a user's desired direction will be described with reference to FIG. 2.

The projector module 100 may radiate a content image in the radiation direction D.

For example, as shown in FIG. 2, the projector module 100 may radiate a content image onto a first radiating position D1.

A user may want to radiate the content image onto a second radiating position D2 that is horizontally adjacent to the first radiating position D1. To this end, the projector module 100 may move the content image to the second radiating position D2 by panning about the second axis O2.

The user may want to radiate the content image onto a third radiating position D3 that is perpendicular to the second radiating position D2. To this end, the projector module 100 may move the content image to the third radiating position D3 by tilting about the third axis O3.

In the case in which the third radiating position D3 is a ceiling, the user may want to rotate the image in the opposite direction. Because a position of a head facing the ceiling may be opposite to a position of feet, there are two cases. In this case, the projector module 100 may be spun about the first axis O1 to rotate the content image as much as desired.

As described above, the projector module 100 may output a content image onto a user's desired position by a panning operation, a tilting operation, and a spinning operation.

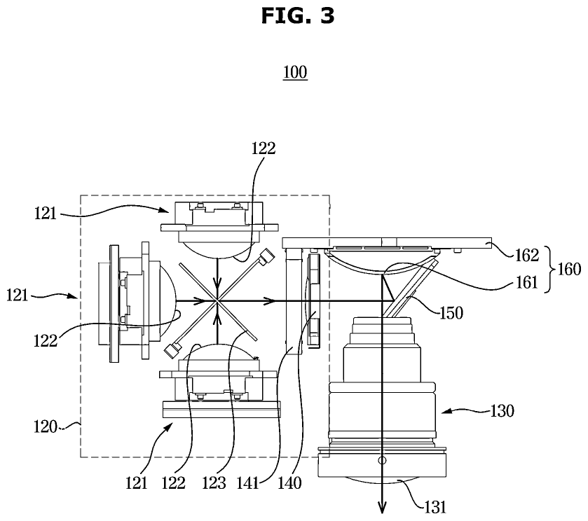

FIG. 3 is a top view showing inside of the projector module 100 of the video output device 1 shown in FIG. 1.

Inside of the video output device 1 or 100 according to an embodiment of the present disclosure will be described with reference to FIG. 3.

The video output device 1 or 100 may include an illumination system 120 that generates light, and a projection system 130. The illumination system 120 may be an optical system configured with optical components arranged from a light source 121 to a display device 162. The illumination system 120 may include the light source 121. The light source 121 may be configured as a light emitter that irradiates Red (R), Green (G), and Blue (B) light. The light emitter may be configured as a Light Emitted Diode (LED). Here, the light source 121 may be configured to emit white light, and in this case, a color separation means (not shown) that separates white light into R, G, and B may be additionally configured.

The illumination system 120 may further include a collimator lens 122, a filter 123, a fly-eye lens 141, and a condenser lens 140. The collimator lens 122 may be positioned in a direction in which light from the light source 121 is emitted. The collimator lens 122 may serve to collect light emitted from the light source 121. Light passed through the collimator lens 122 may pass through the filter 123 and the fly-eye lens 141, and then pass through the condenser lens 140. Through this process, the light may become uniform and be focused.

The video output device 1 or 100 may further include a refractometer 150 and an imaging system 160.

The refractometer 150 may reflect light emitted from the illumination system 120 and transmit the light to the imaging system 160. In this case, the refractometer 150 may be configured using a volume holographic mirror. The refractometer 150 may have a flat mirror shape.

Light reflected through the refractometer 150 may proceed to the imaging system 160. The imaging system 160 may convert an electrical image signal into an optical image by using a display module such as a transmissive liquid crystal display device or a digital micromirror device (DMD). Because the imaging system 160 itself is incapable of generating light, the imaging system 160 may form a projected image by receiving light irradiated from the illumination system 120.

The imaging system 160 may include the display device 162 including the display module, and a relay lens 161 that collects light.

Light transmitted through the imaging system 160 may be projected onto a screen through the projection system 130. The projection system 130 may be configured with a projection lens 131 that enlarges a projected image emitted from the imaging system 160 and projects the image onto the screen, and the projection system 130 may be installed in such a way as to be movable forward and backward in a heading direction of the projected image and adjust a focus according to a distance to the screen. Through this, an image projected onto the screen may be adjusted to be clear.

The illumination system 120 may irradiate light in a direction perpendicular to a heading path of the projected image from a side portion between the imaging system 160 and the projection system 130. In other words, light incident onto the refractometer 150 may travel perpendicular to the heading direction of the projected image. Light irradiated from the illumination system 120 may be incident perpendicularly onto the refractometer 150, and the refractometer 150 may reflect the light toward the imaging system 160.

The imaging system 160 may form a projected image by using the light provided through the refractometer 150 and transmit the projected image to the projection system 130, and the projected image may be transmitted perpendicularly to the heading direction of the light irradiated from the illumination system 120.

The video output device 1 or 100 may include a heat dissipation fan 170 and a heat dissipation fin 171 to discharge heat generated inside the video output device 1 to the outside of the video output device 1.

Through the above-described configuration, the video output device 1 or 100 may project a projected image to display desired information.

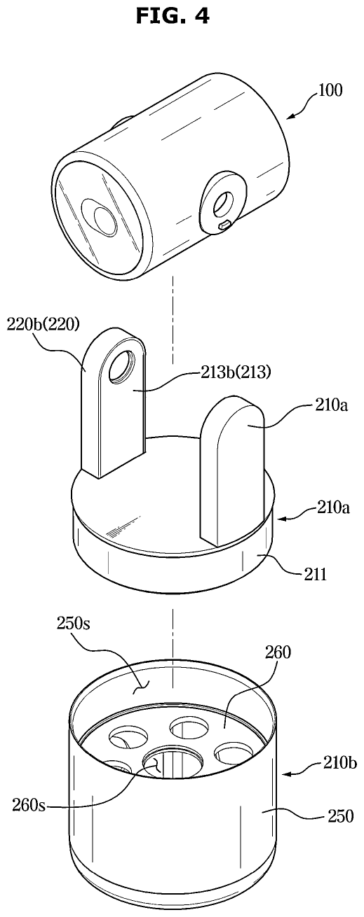

FIG. 4 is an exploded view of the video output device 1 shown in FIG. 1.

The housing 200 of the video output device 1 will be described with reference to FIG. 4.

The video output device 1 may include the housing 200 that supports the projector module 100.

The housing 200 may include a first part housing 210a and a second part housing 210b. The first part housing 210a and the second part housing 210b may be components constituting the housing 200.

The second part housing 210b may be rotatably coupled to the first part housing 210a.

That is, the second rotating device 500 may rotate the projector module 100 about the second axis O2 by rotating the first part housing 210a relative to the second part housing 210b.

The second part housing 210b may be a component that defines a lower appearance of the housing 200. The second part housing 210b may be a component that defines a side appearance of the housing 200.

The second part housing 210b may be spaced from the projector module 100.

The second part housing 210b may be adjacent to the first part housing 210a. The second part housing 210b may be located adjacent to a lower side of the first part housing 210a.

The second part housing 210b may support the first part housing 210a.

The second part housing 210b may move with respect to the first part housing 210a. The second part housing 210b may be rotatable relative to the first part housing 210a. The second part housing 210b may be rotatable relative to the first part housing 210a about the second axis O2.

The second part housing 210b may support a lower side of the first part housing 210a without limiting a rotation.

The second part housing 210b may have a cylindrical shape, although not limited thereto.

The second part housing 210b may cover at least a portion of the first part housing 210a.

The first part housing 210a may be a component that defines an upper appearance of the housing 200.

At least a portion of the first part housing 210a may be accommodated in the second part housing 210b.

The first part housing 210a may be supported by the second part housing 210b.

The first part housing 210a may be in contact with the second part housing 210b. The first part housing 210a may be positioned on the second part housing 210b. The first part housing 210a may be supported by an upper surface of the second part housing 210b.

The first part housing 210a may have a shape corresponding to the second part housing 210b. The first part housing 210a may have a cut portion accommodated in the second part housing 210b.

The first part housing 210a may have a cylindrical shape at a side that faces the second part housing 2010b. The second part housing 210b may define a cylindrical space at a side that faces the first part housing 210a. The cylindrical shape of the first part housing 210a may be accommodated in the space of the second part housing 210b.

A side portion of the first part housing 210a may be surrounded by the second part housing 210b.

The first part housing 210a may be coupled to the projector module 100. The first part housing 210a may be rotatably coupled to the projector module 100. A side of the projector module 100, coupled to the first part housing 210a, may be tilted about the third axis O3.

The first part housing 210a may have a shape extending toward the projector module 100 from the cylindrical shape.

The second part housing 210b may include a housing (200) cover. The housing (200) cover may be a component that defines an appearance of the second par housing 210b.

The housing (200) cover may be a hollow cylindrical shape. A support space 250S may be defined inside the housing (200) cover.

In the case in which the housing (200) cover is a cylindrical shape, a circular base line provided at an end of the cylinder may be defined as an opening.

An edge of the housing (200) cover toward the opening may have a shape tapered to the end. As a result, the first part housing 210a may be easily accommodated in the support space 250S of the housing (200) cover.

The first part housing 210a may be supported by a portion of the housing (200) cover provided at the opening.

The housing (200) cover may be formed of a plastic material, although not limited thereto.

The housing (200) cover may be formed by injection, although not limited thereto.

The housing 200 may include a support plate 260. The support plate 260 may be a component that supports the first housing 200.

The support plate 260 may rotatably support the first part housing 210a.

The support plate 260 may be accommodated in the support space 250S of the housing (200) cover. The support plate 260 may be positioned to partition the support space 250S of the housing (200) cover. The support plate 260 may partition the support space 250S of the housing (200) cover into upper and lower sides.

The support plate 260 may be kept horizontal inside the housing (200) cover and coupled to the housing (200) cover.

The support plate 260 may support the first part housing 210a. The support plate 260 may be located below the first part housing 210a. The support plate 260 may be in contact with the lower side of the first part housing 210a to limit a downward movement of the first part housing 210a.

The support plate 260 may be in contact with a lower edge of the first part housing 210a.

The support plate 260 may support the lower portion of the first part housing 210a, and the cover housing 250 may support the side portion of the first part housing 210a. Accordingly, the second part housing 210b may prevent the first part housing 210a from departing from the support space 250S.

The support plate 260 may have a circular plate shape, although not limited thereto. However, the support plate 260 may have a shape corresponding to the cover housing 250.

The support plate 260 may have a plastic material, although not limited thereto.

The support plate 260 may be formed by injection, although not limited thereto.

The support plate 260 may define a connector hole 260H along the second axis O2. The connector hole 260H may be a hole which a connector 700 (see FIG. 5) which will be described below penetrates.

The support plate 260 may have a plurality of holes 260s arranged along a circumferential direction around the connector hole 260H. Accordingly, the support plate 260 may be light in weight and have a low production cost.

Meanwhile, the support plate 260 may face a seating plate 230. A second gear 530 may be coupled to the support plate 260 between the support plate 260 and the seating plate 230.

The first part housing 210a may include a rotating housing 240. The rotating housing 240 may be a component that defines a lower appearance of the first part housing 210a.

The rotating housing 240 may be inserted in the support space 250S.

The rotating housing 240 may be supported by the support plate 260 at a lower side.

The rotating housing 240 may be supported by the cover housing 250 at a side portion. The cover housing 250 may surround the rotating housing 240. Accordingly, the rotating housing 240 may be prevented from departing from the support space 250S.

The rotating housing 240 may be supported by the edge of the housing (200) cover. The rotating housing 240 may have a shape extending in a radial direction to correspond to the edge of the housing (200) cover.

The rotating housing 240 may have a shape extending upward to be coupled to the projector module 100.

The rotating housing 240 may have a cylindrical shape to be accommodated in the cover housing 250. The rotating housing 240 may have a shape extending from the cylindrical shape toward the projector module 100.

The rotating housing 240 may include the cover housing 250.

The cover housing 250 may accommodate the support plate 260 and at least a portion of the first part housing 210a. The cover housing 250 may rotate together with the support plate 260.

The rotating housing 240 may have a plastic material, although not limited thereto.

The rotating housing 240 may be formed by injection, although not limited thereto.

Meanwhile, the rotating housing 240 may be coupled to the seating plate 230 which will be described below to rotate together with the seating plate 230.

The first part housing 210a may include a side housing 220. The side housing 220 may be a component that covers a side portion of the rotating housing 240.

The side housing 220 may be a component that covers coupling of the projector module 100 and the rotating housing 240.

The side housing 220 may extend upward.

The side housing 220 may define a space between the side housing 220 and the rotating housing 240.

The side housing 220 may have a plastic material, although not limited thereto.

The side housing 220 may be formed by injection, although not limited thereto.

A plurality of side housings 220 may be provided. The side housings 220 may include a first side housing 220a configured to cover one side of the rotating housing 240 and a second side housing 220b configured to cover another side of the rotating housing 240 other than the one side.

The rotating housing 240 may include a support rotating portion 211 accommodated in the support space 250S. The support rotating porting 212 may be a component that is accommodated in the support space 250S and rotatable.

The rotating housing 240 may rotate about the second axis O2 by the second rotating device 500 (see FIG. 7). The rotating housing 240 may rotate relative to the second part housing 210b. The support rotating portion 211 may rotate relative to the second part housing 210b.

The support rotating portion 211 may be supported by the support plate 260. The support rotating portion 211 may extend upward from the support plate 260. The support rotating portion 211 may extend upward from an edge of the support plate 260.

At an upper side of the support rotating portion 211, a portion further extending in a radial direction than the support plate 260 may be provided. An upper edge of the support rotating portion 211 may be in contact with and supported by the housing (200) cover.

The support rotating portion 211 may have a substantially cylindrical shape, although not limited thereto. However, the support rotating portion 211 may correspond to the support space 250S.

The rotating housing 240 may include a side coupling portion 213. The side coupling portion 213 may be a component coupled to the projector module 100.

The side coupling portion 213 may extend from the support rotating portion 211. The side coupling portion 213 may extend upward. The side coupling portion 213 may extend toward the projector module 100.

The side coupling portion 213 may be coupled to a side portion of the projector module 100.

The side coupling portion 213 may cover a component between the projector module 100 and the second part housing 210b.

An outer side of the side coupling portion 213 may be covered by the side housing 220. The side coupling portion 213 may correspond to the side housing 220.

A plurality of side coupling portions 213 may be provided. The plurality of side coupling portions 213 may include a first side coupling portion 213a corresponding to the first side housing 220a and a second side coupling portion 213b corresponding to the second side housing 220b.

FIG. 5 is an exploded view of the second part housing 210b and a part of internal components in the video output device 1 shown in FIG. 4.

The third rotating device 600 according to an embodiment of the disclosure will be described with reference to FIG. 5.

The video output device 1 may include the third rotating device 600. The third rotating device 600 may be a device capable of rotating the projector module 100 about the third axis O3. The third rotating device 600 may be a device capable of tilting the projector module 100.

The third rotating device 600 may be configured to rotate the projector module 100 about the third axis O3 intersecting the first axis O1 and the second axis O2.

The third rotating device 600 may be located inside the housing 200. The third rotating device 600 may be located inside the first part housing 210a.

The third rotating device 600 may be coupled to the projector module 100 along the third axis O3. The third rotating device 600 may be rotatably coupled to the projector module 100.

The third rotating device 600 may be located between the side housing 220 and the side coupling portion 213 of the rotating housing 240. The third rotating device 600 may be covered by the side housing 220.

The third rotating device 600 may be located inside the first part housing 210a. Accordingly, the third rotating device 600 may be covered.

The third rotating device 600 may include a tilting motor 610. The tilting motor 610 may be a component of which a shaft is rotatable by an electrical signal.

The tilting motor 610 may include a stator, and a rotor that is rotatable relative to the stator. The rotor may be connected to a rotation shaft. The rotor may rotate through magnetic interaction with the stator, and a rotation of the rotor may be transmitted to a component connected to the rotor through the rotation shaft.

The tilting motor 610 may include a BrushLess Direct Current Motor (BLDC Motor) 610 capable of easily controlling a rotation speed or a Permanent Synchronous Motor (PMSM) 610.

The tilting motor 610 may be controlled by a processor which will be described below. The processor may control the motor 510 through a tilting motor (610) drive.

The tilting motor (610) drive may receive a driving signal for driving the tilting motor 610 from the processor, and supply driving current for rotating the rotation shaft of the motor 510 to the tilting motor 610 based on the driving signal from the processor. For example, the tilting motor (610) drive may receive a driving signal including a speed command of the tilting motor 610 and supply driving current to the tilting motor 610 such that a rotation speed of the tilting motor 610 follows the speed command.

Also, the tilting motor (610) drive may provide a driving current value supplied to the tilting motor 610 and the rotation speed of the tilting motor 610 to the processor. The processor may inspect the third rotating device 600 based on the driving current of the tilting motor 610. Also, the processor may identify a driving frequency of the third rotating device 600 based on the rotation speed of the tilting motor 610.

For example, according to the tilting motor 610 being a BLDC Motor 510, the tilting motor (610) drive may supply pulse-width modulated DC current to the tilting motor 610. Also, according to the tilting motor 610 being a PMSM 510, the tilting motor (610) drive may supply AC current to the tilting motor 610 using vector control.

Meanwhile, the tilting motor 610 may be configured to be supported by the support plate 260.

The third rotating device 600 may include a first pulley 620. The first pulley 620 may be a pulley connected to the tilting motor 610.

The first pulley 620 may be rotated by the tilting motor 610.

The first pulley 620 may be coupled to the rotation shaft of the tilting motor 610. The first pulley 620 may rotate together with the rotation shaft of the tilting motor 610 while the tilting motor 610 is driven.

The first pulley 620 may have a wheel shape with a groove defined in the center.

The rotation shaft of the tilting motor 610 may be parallel to the third axis O3. The rotation shaft of the first pulley 620 may be parallel to the third axis O3.

The first pulley 620 may have a plastic material, although not limited thereto.

The first pulley 620 may be formed by injection, although not limited thereto.

The first pulley 620 may be coupled to the tilting motor 610 to be rotated by the tilting motor 610.

The third rotating device 600 may include a second pulley 630. The second pulley 630 may be a pulley coupled to the projector module 100.

The second pulley 630 may be positioned between the side housing 220 and the side coupling portion 213 of the rotating housing 240. The second pulley 630 may be prevented from being exposed to the outside by the side housing 220.

The second pulley 630 may be coupled to the projector module 100. The projector module 100 may rotate together with the second pulley 630 while the second pulley 630 rotates.

The second pulley 630 may be coupled to the projector module 100 along the third axis O3. Accordingly, while the second pulley 630 rotates, the projector module 100 may rotate together with the second pulley 630 about the third axis O3 as a rotation axis.

The second pulley 630 may have a wheel shape with a groove defined in the center. The second pulley 630 including the groove may be on the same plane as that of the first pulley 620 including the groove.

A rotation axis of the second pulley 630 may be parallel to a rotation axis of the first pulley 620.

The second pulley 630 may rotate by interworking with a rotation of the first pulley 620. The second pulley 630 may rotate by a force transmitted from the first pulley 620. While the second pulley 630 rotates by the first pulley 620, the second pulley 630 may rotate the projector module 100.

A radius of the second pulley 630 may be larger than a radius of the first pulley 620. Because the second pulley 630 rotates by interworking with the first pulley 620, the second pulley 630 may have a lower rotation speed than the first pulley 620 and a greater rotation force than the first pulley 620.

Controlling the projector module 100 may not require a high speed. However, despite a weight of the projector module 100, a force to control the projector module 100 may be required to control the projector module 100. A radius ratio of the second pulley 630 and the first pulley 620 may be referred to as a magnitude ratio of forces transmitted from the motor 510. Therefore, because the second pulley 630 has a greater radius than the first pulley 620, a force transmitted from the motor 510 may further increase.

Meanwhile, the second pulley 630 may be coupled to the projector module 100.

The third rotating device 600 may have a rail 640. The rail 640 may connect the first pulley 620 and the second pulley 630.

The rail 640 may be positioned between the side housing 220 and the side coupling portion 213 of the rotating housing 240. The rail 640 may be prevented from being exposed to the outside by the side housing 220.

The rail 640 may be coupled to the first pulley 620 and the second pulley 630 such that the projector module 100 rotates while the first pulley 620 rotates.

The rail 640 may transfer a rotation generated from the first pulley 620 to the second pulley 630. The rail 640 may connect the first pulley 620 with the second pulley 630.

The rail 640 may be rested on the groove of the first pulley 620. The rail 640 may be rested on the groove of the second pulley 630.

The rail 640 may have a closed curve shape. The rail 640 may have a belt shape.

The rail 640 may have elasticity.

The rail 640 may be in contact with at least a portion of an outer surface of the first pulley 620 and at least a portion of an outer surface of the second pulley 630.

While the first pulley 620 rotates, a portion of the rail 640 that is in contact with the first pulley 620 may move together. While the rail 640 moves, the portion of the second pulley 630 that is in contact with the rail 640 may move together. As a result, the second pulley 630 may rotate. While the second pulley 630 rotates, the projector module 100 coupled to the second pulley 630 may rotate together.

The rail 640 may have an elastic material. The rail 640 may have a rubber material.

The third rotating device 600 may include a third wire L3. The third wire L3 may be a component that electrically connects the tilting motor 610 to another component.

The third wire L3 may be coupled to the tilting motor 610.

The first part housing 210a may include a rotating connector 240. The rotating connector 240 may be a component corresponding to the second pulley 630.

The second pulley 630 may rotate the projector module 100 at a right or left side of the projector module 100.

The rotating connector 240 may support the projector module 100 at a left or right side of the projector module 100, not connected to the second pulley 630. The rotating connector 240 may be coupled to the projector module 100.

The rotating connector 240 may be rotatably coupled to the rotating housing 240. The rotating connector 240 may be rotatably coupled to the side coupling portion 213.

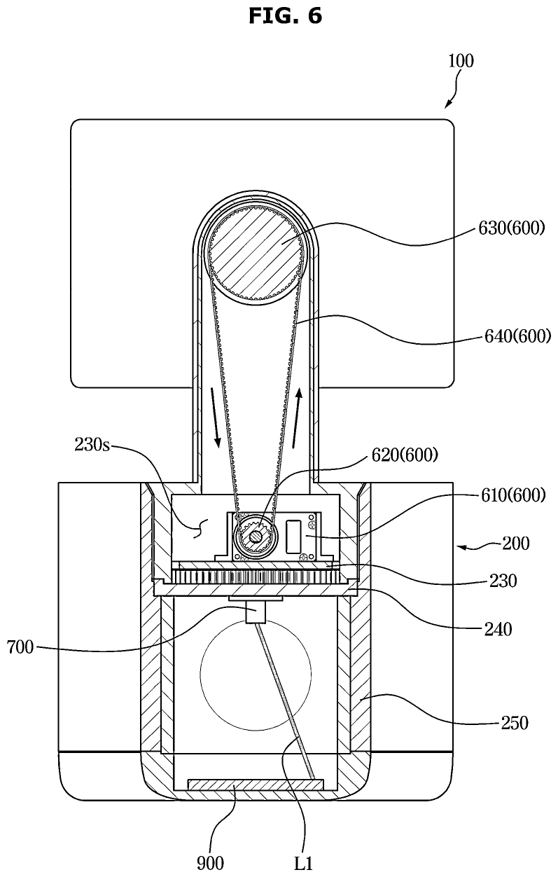

The first part housing 210a may include the seating plate 230. The seating plate 230 may be a component that defines a resting space 230S (see FIG. 6) between the seating plate 230 and the rotating housing 240.

The seating plate 230 may be positioned inside the rotating housing 240.

The seating plate 230 may be positioned in a lower portion of the rotating housing 240.

The resting space 230S may be surrounded by an upper side of the seating plate 230 and the rotating housing 240.

The third rotating device 600 may be positioned on the seating plate 230.

The tilting motor 610 may be positioned on the seating plate 230. The tilting motor 610 may be coupled to the seating plate 230.

The seating plate 230 may correspond to the rotating housing 240. The seating plate 230 may have a circular plate shape.

The seating plate 230 may be coupled to the rotating housing 240.

The seating plate 230 may rotate together while the rotating housing 240 rotates.

The seating plate 230 may have a plastic material, although not limited thereto.

The seating plate 230 may be formed by an injection process, although not limited thereto.

Meanwhile, the seating plate 230 may be configured such that the motor 510 is located on one side of the seating plate 230 and a substrate 900 faces another side of the seating plate 230 which is opposite to the one side.

FIG. 6 is a cross-sectional view of the video output device 1 shown in FIG. 1.

Rotating the projector module 100 by the third rotating device 600 will be described with reference to FIG. 6.

The video output device 1 may include the third rotating device 600.

The third rotating device 600 may include the tilting motor 610, the first pulley 620, the second pulley 630, and the rail 640.

The tilting motor 610 may rotate the first pulley 620. By the rotation of the first pulley 620, the rail 640 may move. By the movement of the rail 640, the second pulley 630 may rotate.

While the second pulley 630 rotates, the projector module 100 connected to the second pulley 630 may rotate. The projector module 100 may tilt.

The tilting motor 610 may be mounted on the support plate 260. The tilting motor 610 may be located in the mounting space 230S defined between the support plate 260 and the rotating housing 240. The tilting motor 610 may not move about the third axis O3 together with the rotating housing 240.

The first pulley 620 coupled to the tilting motor 610 may also not move about the third axis O3.

The rail 640 coupled to the first pulley 620 and the second pulley 630 coupled to the rail 640 may also not move about the third axis O3.

The projector module 100 may be tilted relative to the rotating housing 240. The projector module 100 may be tilted relative to the first part housing 210a. The projector module 100 may be tilted relative to the housing 200.

The third rotating device 600 may also allow driving by a user, in addition to driving by the tilting motor 610. That is, the third rotating device 600 may not limit a user's force of tiling the projector module 100. While a user applies a force, the first pulley 620, the second pulley 630, and the rail 640 may guide tiling of the projector module 100.

FIG. 7 is an exploded view of the second part housing 210b and a part of internal components in the video output device 1 shown in FIG. 4.

The second rotating device 500 according to an embodiment of the present disclosure will be described with reference to FIG. 7.

The video output device 1 may include the second rotating device 500. The second rotating device 500 may be a device capable of rotating the projector module 100 about the second axis O2. The second rotating device 500 may be a device capable of panning the projector module 100.

The second rotating device 500 may be located inside the housing 200. The housing 200 may prevent the second rotating device 500 from being exposed to the outside.

The second rotating device 500 may be coupled to the first part housing 210a. The second rotating device 500 may be coupled to the second part housing 210b.

The second rotating device 500 may apply a force to rotate the second part housing 210b. However, while the video output device 1 is positioned on the floor, the second part housing 210b may not move because the second part housing 210b is in contact with the floor. While the second part housing 210b does not move, the first part housing 210a may move by reaction. As a result, the projector module 100 may rotate.

The second rotating device 500 may be coupled to the second part housing 210b. The second rotating device 500 may transfer a force to the second part housing 210b.

The second rotating device 500 may connect the first part housing 210a to the second part housing 210b. The second rotating device 500 may move the first part housing 210a by applying a force to the second part housing 210b.

The second rotating device 500 may include the motor 510. The motor 510 may be a component of which a shaft is rotatable by an electrical signal.

The motor 510 may include a stator, and a rotor that is rotatable relative to the stator. The rotor may be connected to a rotation shaft. The rotor may rotate through magnetic interaction with the stator, and a rotation of the rotor may be transmitted to a component connected to the rotor through the rotation shaft.

The motor 510 may include, for example, a BLDC Motor 510 capable of easily controlling a rotation speed or a PMSM 510.

The motor 510 may be controlled by the processor which will be described below. The processor may control the motor 510 through a motor (510) drive.

The motor (510) drive may receive a driving signal for driving the motor 510 from the processor, and supply driving current for rotating the rotation shaft of the motor 510 to the motor 510 based on the driving signal from the processor. For example, the motor (510) drive may receive a driving signal including a speed command of the motor 510 and supply driving current to the motor 510 such that a rotation speed of the motor 510 follows the speed command.

Also, the motor (510) drive may provide a driving current value supplied to the motor 510 and the rotation speed of the motor 510 to the processor. The processor may inspect the third rotating device 600 based on the driving current of the motor 510. Also, the processor may identify a driving frequency of the third rotating device 600 based on the rotation speed of the motor 510.

For example, according to the motor 510 being a BLDC Motor 510, the motor (510) drive may supply pulse-width modulated DC current to the motor 510. Also, according to the motor 510 being a PMSM 510, the motor (510) drive may supply AC current to the motor 510 using vector control.

The motor 510 may be spaced in a radial direction from the second axis O2.

The motor 510 may be located on the support plate 260. The motor 510 may be coupled to the support plate 260.

The second rotating device 500 may include a first gear 520. The first gear 520 may be a gear connected to the motor 510.

The first gear 520 may be rotated by the motor 510.

The first gear 520 may be coupled to the rotation shaft of the motor 510. While the motor 510 is driven, the first gear 520 may rotate together with the rotation shaft of the motor 510.

The first gear 520 may be a spur gear, although not limited thereto. However, the first gear 520 may be a worm gear. According to the first gear 520 being a worm gear, panning of the projector module 100 by a user may be limited.

The rotation shaft of the motor 510 may be parallel to the second axis O2. The rotation shaft of the first gear 520 may be parallel to the second axis O2.

The motor 510 may be located on one side of the seating plate 230. The first gear 520 may be located on another side of the seating plate 230, which is opposite to the one side of the seating plate 230. The shaft of the motor 310 may penetrate the seating plate 230.

The motor 510 may be located on an upper side of the seating plate 230. The first gear 520 may be located on a lower side of the seating plate 230.

The first gear 520 may have a metal material, although not limited thereto.

The first gear 520 may be manufactured by a milling process, although not limited thereto.

The second rotating device 500 may include a second gear 530. The second gear 530 may be a gear engaged with the first gear 520.

The second gear 530 may be engaged with the first gear 520, rotatable about the second axis O2 as a rotation axis, and coupled to the second part housing 210b.

The second gear 530 and the first gear 520 may be located on the same surface of the seating plate 230 such that the second gear 530 is engaged with the first gear 520. The second gear 530 may be located on a lower side of the support plate 260.

The rotation axis of the second gear 530 may be the same as the second axis O2. While the projector module 100 is panned, the second gear 530 may only perform rotation motion without any translational motion.

The second gear 530 may be coupled to the second part housing 210b. While the second part housing 210b is in contact with the floor, the second part housing 210b may be limited in rotating. While the second part housing 210b is limited in rotating, the second gear 530 may also be limited in rotating.

While the second gear 530 is limited in rotating, the first gear 520 may perform orbital motion around the second gear 530. The first gear 520 may move around the second gear 530 while rotating about the second axis O2. While the first gear 520 moves around the second gear 530 by rotating about the second axis O2, the motor 510 connected to the first gear 520 may perform orbital motion around the second axis O2. The seating plate 230 connected to the motor 510 may also perform orbital motion around the second axis O2. The rotating housing 240 connected to the seating plate 230 may also perform orbital motion around the second axis O2. The projector module 100 connected to the rotating housing 240 may also perform orbital motion around the second axis O2.

The second gear 530 may have a metal material, although not limited thereto.

The second gear 530 may be formed by milling, although not limited thereto.

The second gear 530 may have a hole at a position corresponding to the rotation axis.

The second rotating device 500 may further include a bearing 540. The bearing 540 may be a component configured to smoothly rotate the second gear 530.

The bearing 540 may be coupled to the second gear 530. The bearing 540 may share the same rotation axis as the second gear 530 and may be coupled to the second gear 530.

The bearing 540 may be accommodated in the hole defined at a center of rotation of the second gear 530. The bearing 540 may be in contact with the second gear 530 at an inner side of the hole in the second gear 530.

The bearing 540 may have substantially the same diameter as the hole of the second gear 530.

The bearing 540 may reduce friction between the second gear 530 and another component being in contact with the bearing 540, while the second gear 530 rotates.

The bearing 540 may be positioned between the second gear 530 and a connector 700 which will be described later. Accordingly, while the connector 700 rotates relative to the second gear 530, a frictional influence of the second gear 530 against the connector 700 may be reduced.

The bearing 540 may be coupled to the seating plate 230. The bearing 540 may be located on the seating plate 230. The bearing 540 may be in contact with the seating plate 230. The bearing 540 may be located on the lower side of the seating plate 230.

The bearing 540 may be positioned between a bearing support 550 which will be described below and the seating plate 230. As a result, the bearing 540 may be prevented from moving in the up-down direction.

The bearing 540 may have a ring shape. The bearing 540 may have a hole defined at a position corresponding to the second axis O2. The connector 700 which will be described below may be inserted into the hole of the bearing 540.

The bearing 540 may include a ball bearing 540.

Meanwhile, the bearing 540 may be positioned between the second gear 530 and the seating plate 230 so as to be rotatable relative to the second gear 530.

The second rotating device 500 may include the bearing support 550. The bearing support 550 may be a component that supports the bearing 540.

The bearing support 550 may be coupled to the seating plate 230. The bearing support 550 may accommodate the bearing 540 between the bearing support 550 and the seating plate 230.

The bearing support 550 may be coupled to the lower side of the seating plate 230.

The bearing support 550 may be positioned on the lower side of the second gear 530.

The bearing support 550 may support the connector 700 which will be described below.

The bearing support 550 may have a ring shape. A hole may be defined at a position corresponding to the second axis O2 in the bearing support 550. The connector 700 may be inserted into the hole of the bearing support 550.

The bearing support 550 may have a plastic material, although not limited thereto.

The bearing support 550 may be formed by injection, although not limited thereto.

The second rotating device 500 may include a second wire L2. The second wire L2 may be a component that electrically connects the motor 510 to another component.

The second wire L2 may be connected to the motor 510.

The second wire L2 may be located on the upper side of the seating plate 230.

The video output device 1 may include the connector 700. The connector 700 may be a component that connects wires.

The connector 700 may be inserted and positioned in the seating plate 230. A side of the connector 700 may protrude upward from the support plate 260. Another side of the connector 700 may protrude downward from the support plate 260.

The connector 700 may be electrically connected to the substrate 900 through the first wire L1, and may be electrically connected to the second rotating device 500 through the second wire L2. The connector 700 may prevent the first wire L1 and the second wire L2 from being twisted while the projector module 100 rotates about the second axis O2.

Meanwhile, the connector 700 may penetrate the seating plate 230.

The connector 700 may be connected to the second wire L2 or the third wire L3. The connector 700 will be described in detail with the associated drawings.

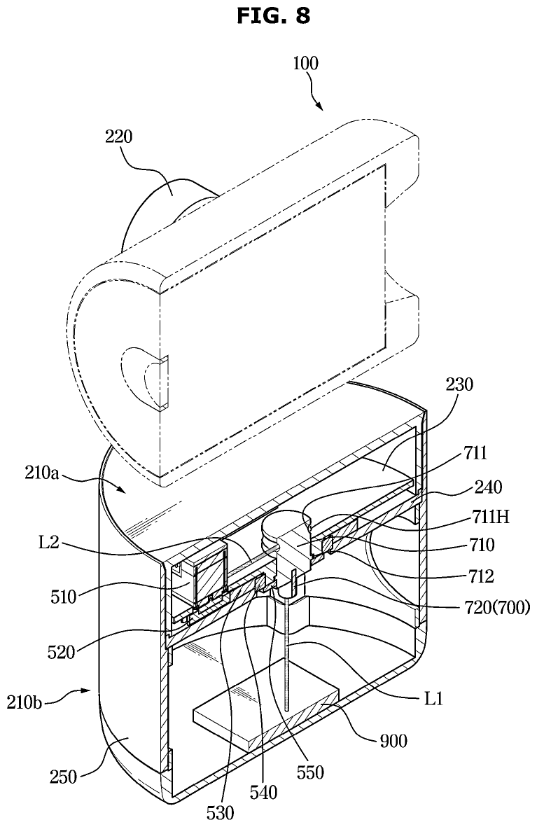

FIG. 8 is a cross-sectional perspective view of the video output device 1 shown in FIG. 1.

An electrical connection of the video output device 1 will be described with reference to FIG. 8.

The video output device 1 may include the connector 700.

To describe which wire the connector 700 is connected to, an internal electrical connection of the video output device 1 will be described.

To this end, the substrate 900 will be described.

The video output device 1 may include the substrate 900. The substrate 900 may be a component provided to control electrical components.

The substrate 900 may be electrically connected to the second rotating device 500.

The substrate 900 may be located inside the housing 200.

The substrate 900 may be located inside the cover housing 250.

The substrate 900 may be opposite to the motor 510 with respect to the seating plate 230, although not limited thereto. However, the substrate 900 and the motor 510 may be located on the same side of the seating plate 230.

The substrate 900 may be located below the seating plate 230. The substrate 900 may be located below the support plate 260.

The substrate 900 may have a quadrangular shape.

The video output device 1 may include a first wire L1 connected to the substrate 900. The first wire L1 may be a component that connects the substrate 900 to electrical components.

The first wire L1 may extend from the substrate 900.

The motor (510) drive that controls the motor 510 may be located on the substrate 900.

Accordingly, the motor 510 may need to be electrically connected to the substrate 900.

The motor 510 may be electrically connected to the second wire L2. The substrate 900 may be electrically connected to the first wire L1.

The connector 700 may be electrically connected to the first wire L1 and the second wire L2. The connector 700 may electrically connect the substrate 900 to the motor 510.

The tilting motor 610 may be connected to the third wire L3. The third wire L3 may be connected to the connector 700.

A spinning motor 410 (see FIG. 11) which will be described below may be connected to a fourth wire L4 (not shown). The fourth wire L4 may be connected to the connector 700, although not limited thereto.

However, the third wire L3 may be connected to the motor 510. The fourth wire L4 may be connected to the motor 510. In this case, the motor 510 may include a separate controller, in addition to the stator and the rotor.

A detailed function of the connector 700 will be described in detail with reference to the related drawings, below.

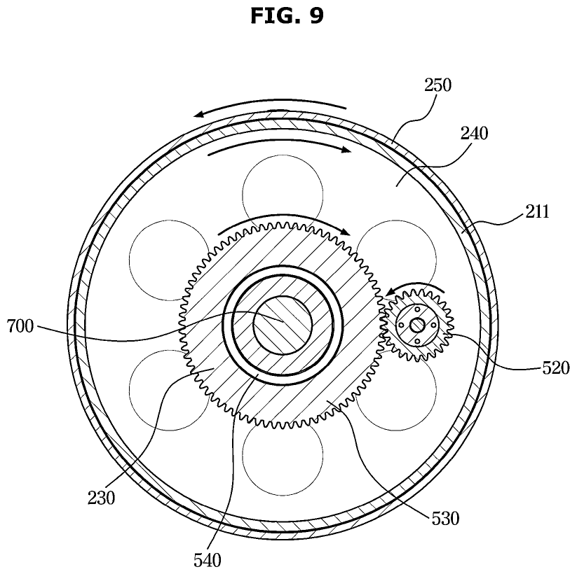

FIG. 9 is a cross-sectional view of the video output device 1 shown in FIG. 1.

Panning of the video output device 1 according to an embodiment of the present disclosure will be described with reference to FIG. 9.

The video output device 1 may include the second rotating device 500.

The second rotating device 500 may include the motor 510 (see FIG. 8).

The motor 510 may rotate the first gear 520. For example, the motor 510 may rotate the first gear 510 in a counterclockwise direction.

The first gear 520 may rotate the second gear 530 engaged with the first gear 520. The second gear 530 may rotate in an opposite direction of a rotation direction of the first gear 520. For example, while the first gear 520 rotates in the counterclockwise direction, the second gear 530 may rotate in a clockwise direction.

Because the seating plate 230 is coupled to the second gear 530, the seating plate 230 may rotate in the same direction as the second gear 530. For example, while the second gear 530 rotates in the clockwise direction, the seating plate 230 may rotate in the clockwise direction.

Because the cover housing 250 is coupled to the seating plate 230, the cover housing 250 may rotate in the same direction as the seating plate 230. For example, while the seating plate 230 rotates in the clockwise direction, the cover housing 250 may rotate in the clockwise direction.

However, the cover housing 250 may be fixed to the floor. In the case in which the cover housing 250 is fixed to the floor, the seating plate 230 may also be fixed. While the seating plate 230 is fixed, the second gear 530 may also be fixed.

While the second gear 530 is fixed, the first gear 520 may move while rotating around the second gear 530. For example, while the first gear 520 rotates in the counterclockwise direction, the first gear 520 may move around the second gear 530 in the counterclockwise direction. That is, the first gear 520 may move along a circumferential direction in the counterclockwise direction about the second axis O2.

While the first gear 520 moves, the motor 510 coupled to the first gear 520 may move together. For example, while the first gear 520 moves in the counterclockwise direction along a circumferential direction of the second axis O2, the motor 510 may move in the counterclockwise direction.

While the motor 510 moves, the seating plate 230 (see FIG. 8) coupled to the motor 510 may move together. For example, while the motor 510 moves in the counterclockwise direction along the circumferential direction of the second axis O2, the seating plate 230 may move in the counterclockwise direction.

While the seating plate 230 moves, the rotating housing 240 (see FIG. 8) coupled to the seating plate 230 may move together. For example, while the seating plate 230 moves in the counterclockwise direction along the circumferential direction of the second axis O2, the rotating housing 240 may move in the counterclockwise direction.

While the rotating housing 240 moves, the projector module 100 coupled to the rotating housing 240 may move together. For example, while the rotating housing 240 moves in the counterclockwise direction along the circumferential direction of the second axis O2, the projector module 100 may move in the counterclockwise direction.

For example, while the first gear 520 rotates in the counterclockwise direction, the projector module 100 may rotate in the counterclockwise direction in the circumferential direction of the second axis O2.

While the first gear 520 moves in the clockwise direction, the direction in the above description may be reversed.

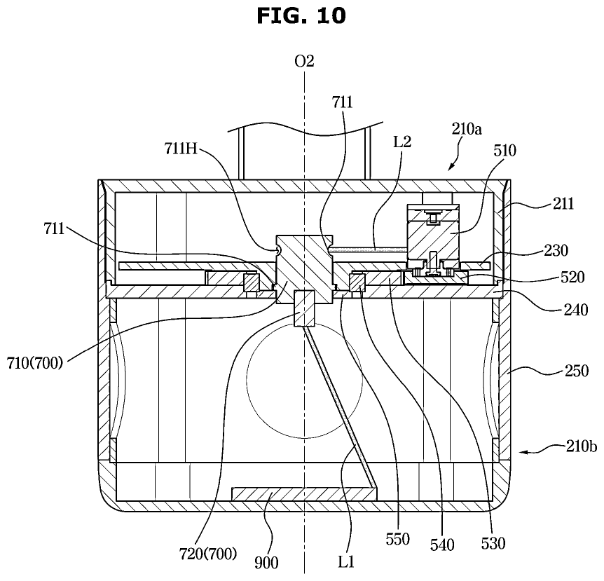

FIG. 10 is a cross-sectional view of the video output device 1 shown in FIG. 1.

The connector 700 according to an embodiment of the present disclosure will be described with reference to FIG. 10.

The video output device 1 may include the connector 700.

The connector 700 may include a fixed body 710 coupled to the seating plate 230.

The fixed body 710 may rotate together with the seating plate 230. While the seating plate 230 rotates according to the first gear 520, as described above, the fixed body 710 may also rotate together.

The fixed body 710 may penetrate the seating plate 230.

The fixed body 710 may penetrate the bearing 540. The fixed body 710 may be positioned between the bearing 540 and the second gear 530. The bearing 540 may prevent the fixed body 710 from being limited in rotating while the fixed body 710 rotates relative to the second gear 530.

The fixed body 710 may have a cylindrical shape.

Meanwhile, the fixed body 710 may include an accommodating groove capable of accommodating the second wire L2 connected to the second rotating device 500. The fixed body 710 may include a terminal that contacts the first wire L1 in the accommodating groove. The fixed body 710 may be coupled to the first part housing 210a.

The fixed body 710 may include a step portion 711. The step portion 711 may be a component protruding in the radial direction.

The step portion 711 may extend in a circumferential direction of the fixed body 710.

The step portion 711 may be in contact with the seating plate 230 at one side, and in contact with a bearing (540) support at another side. Accordingly, the fixed body 710 may be located between the seating plate 230 and the bearing (540) support. The step portion 711 may prevent the fixed body 710 from moving upward from the seating plate 230. The step portion 711 may prevent the fixed body 710 from moving downward from the bearing support 550. The step portion 711 may limit a movement of the fixed body 710.

The fixed body 710 may include a contact groove 711H. The contact groove 711H may be a groove that is concave inwardly along the circumferential direction of the fixed body 710.

The second wire L2 may be accommodated in the contact groove 711H. The contact groove 711H may guide the second wire L2 to be located along the contact groove 711H.

While the fixed body 701 rotates by a rotation of the seating plate 230, the second wire L2 may be prevented from departing from the contact groove 711H by the contact groove 711H.

The fixed body 710 may include a contact portion 711. The contract portion 711 may be a component which a wire contacts.

The contact portion 711 may be located inside the contact groove 711H.

The contact portion 711 may be located along the circumferential direction of the fixed body 710.

Because the second wire L2 is accommodated in the contact groove 711H, the second wire L2 may contact the contact portion 711. The second wire L2 may contact the contact portion 711. According to a rotation of the fixed body 710, the second wire L2 may maintain contact with the contact portion 711.

The contact portion 711 may have a conductor material. Accordingly, the contact portion 711 may be electrically connected to the second wire L2.

Even while the fixed body 710 rotates by a rotation of the seating plate 230, the contact portion 711 may maintain an electrical connection to the second wire L2. While the fixed body 710 rotates, the second wire L2 may maintain a connection to the contact portion 711 without changing in position.

While the seating plate 230 rotates about the second axis O2, the motor 510 may perform orbital motion around the second axis O2 because the motor 510 is spaced from the second axis O2. The motor 510 may move in a circle around the second axis O. Because the second wire L2 connecting the motor 510 to the connector 700 maintains contact with the contact portion 711 of the fixed body without being coupled to the fixed body 710, the second wire L2 may be prevented from being twisted.

The case of the second wire L2 may also be applied in the same way to the third wire L3 (see FIG. 6) coupled to the tilting motor 610 and the fourth wire L4 (see FIG. 11) coupled to the spinning motor 410 (see FIG. 11).

The connector 700 may include a rotating body 720. The rotating body 720 may be a component that is rotatable relative to the fixed body 710.

The rotating body 720 may be rotatably coupled to the fixed body 710. The rotating body 720 may be electrically connected to the fixed body 710.

The rotating body 720 may protrude from the fixed body 710 toward the substrate 900.

The rotating body 720 may be electrically connected to the first wire L1 connected to the substrate 900.

While the fixed body 710 rotates, the rotating body 720 may be prevented from being influenced by the rotation of the fixed body 710 because the rotating body 720 is rotatably coupled to the fixed body 710. That is, while the fixed body 710 rotates, the rotating body 720 may be limited in rotating.

Because the first wire L1 is coupled to the rotating body 720, the first wire L1 may be prevented from being twisted even while the fixed body 710 rotates.

In other words, because the first wire L1 extending from the substrate 900 does not extend along the second axis O2, the first wire L1 may be twisted while rotating. However, because the first wire L1 is connected to the rotating body 720 of the connector 700 and the rotating body 720 may not rotate although the fixed body 710 rotates, the first wire L2 may be prevented from being twisted.

That is, the connector 700 may prevent the first wire L1, the second wire L2, the third wire L3, and the fourth wire L4 from being twisted.

Embodiments of the present disclosure may be a structure capable of rotating infinitely. In the case in which tilting, panning, and spinning are capable of rotating infinitely, there is a possibility that wires will be twisted. Without the connector 700, it may be difficult to prevent the wires from being twisted, and accordingly, the connector 700 may be required to ensure a rotation in any direction without limitation.

Meanwhile, the rotating body 720 may be connected to the first wire L1 connected to the substrate 900 and coupled to the fixed body 710 in such a way as to be rotatable relative to the fixed body 710. While the projector module 100 rotates about the second axis O2, the rotating body 720 may allow the first wire L1 to rotate about the second axis O2 as a rotation axis.

Meanwhile, the motor 510 may be spaced apart from the second axis O2 to orbit about the second axis O2 while the first part housing 210a rotates, and the connector 700 may prevent the second wire L2 connected to the motor 510 from moving and maintain an electrical connection.

Meanwhile, the substrate 900 may be accommodated in the second part housing 210b. The connector 700 may prevent the first wire L1 connected to the substrate 900 from being twisted and maintain an electrical connection.

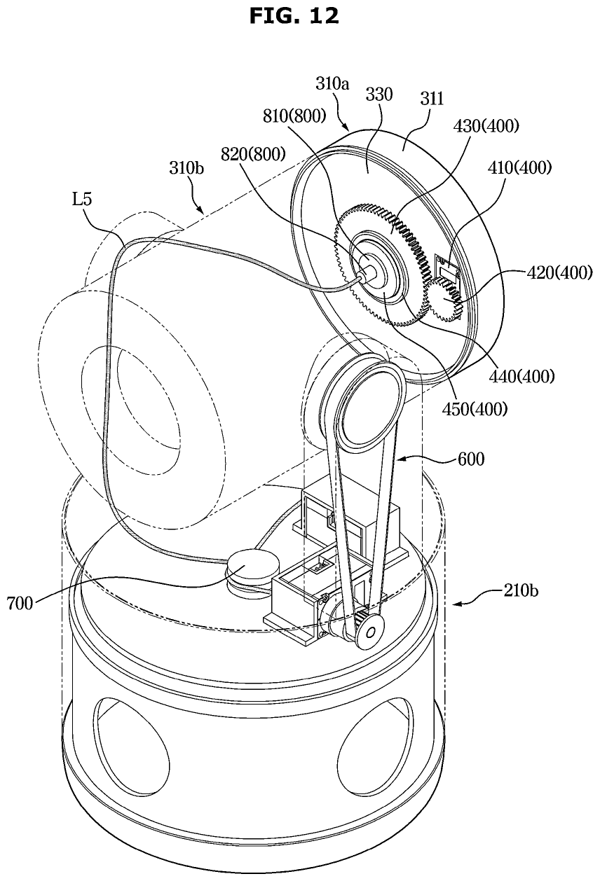

FIG. 11 is a perspective view showing the projector module 100 of the video output device 1 shown in FIG. 1. FIG. 12 is a perspective view showing the video output device 1 shown in FIG. 1.

Spinning according to an embodiment of the present disclosure will be described with reference to FIGS. 11 and 12.

The projector module 100 may include a spinning housing 300. The spinning housing 300 may be a component that defines an appearance of the projector module 100.

The spinning housing 300 may include a first part spinning housing 310a that defines a front appearance and a second part spinning housing 310b that defines a rear appearance.

The second part spinning housing 310b may include a spinning seating plate 330 on which a spinning motor 410, etc., which will be described later, is mounted.

The second part spinning housing 310b may be rotatably coupled to the first part spinning housing 310a.

The first part spinning housing 310a may include a spinning support plate 260 that supports the second part spinning housing 310b.

The video output device 1 may include a first rotating device 400. The first rotating device 400 may be a device capable of rotating the projector module 100 about the first axis O1. The first rotating device 400 may be a device capable of spinning the projector module 100.

The first rotating device 400 may be located inside the spinning housing 300. The spinning housing 300 may prevent the first rotating device 400 from being exposed to the outside.

The first rotating device 400 may be coupled to the first part spinning housing 310a. The first rotating device 400 may be coupled to the second part spinning housing 310b.

The first rotating device 400 may apply a force to rotate the second part spinning housing 310b. However, while the video output device 1 is located on the floor, the second part spinning housing 310b may not move because of being in contact with the rotating housing 240 (see FIG. 5). While the second part spinning housing 310b does not move, the first part spinning housing 310a may move by reaction. As a result, the projector module 100 may rotate.

The first rotating device 400 may be coupled to the second part spinning housing 310b. The first rotating device 400 may transfer a force to the second part spinning housing 310b.

The first rotating device 400 may connect the first part spinning housing 310a to the second part spinning housing 310b. The first rotating device 400 may apply a force to the second part spinning housing 310b to move the first part spinning housing 310a.

The first rotating device 400 may include a spinning motor 410. The spinning motor 410 may be a component of which a shaft is rotatable by an electrical signal.

The spinning motor 410 may be coupled to the first part spinning housing 310a.

The spinning motor 410 may include a stator, and a rotor that is rotatable relative to the stator. The rotor may be connected to a rotation shaft. The rotor may rotate through magnetic interaction with the stator, and a rotation of the rotor may be transmitted to a component connected to the rotor through the rotation shaft.

The spinning motor 410 may include, for example, a BLDC Motor 410 capable of easily controlling a rotation speed, or a PMSM 410.

The spinning motor 410 may be controlled by the processor which will be described below. The processor may control the spinning motor 410 through a spinning motor (410) drive.

The spinning motor (410) drive may receive a driving signal for driving the spinning motor 410 from the processor, and supply driving current for rotating the rotation shaft of the spinning motor 410 to the spinning motor 410 based on the driving signal from the processor. For example, the spinning motor (410) drive may receive a driving signal including a speed command of the spinning motor 410 and supply driving current to the spinning motor 410 such that a rotation speed of the spinning motor 410 follows the speed command.

Also, the spinning motor (410) drive may provide a driving current value supplied to the spinning motor 410 and the rotation speed of the spinning motor 410 to the processor. The processor may inspect the third rotating device 600 based on the driving current of the spinning motor 410. Also, the processor may identify a driving frequency of the third rotating device 600 based on the rotation speed of the spinning motor 410.

For example, according to the spinning motor 410 being a BLDC Motor 410, the spinning motor (410) drive may supply pulse-width modulated DC current to the spinning motor 410. Also, according to the spinning motor 410 being a PMSM 410, the spinning motor (410) drive may supply AC current to the spinning motor 410 using vector control.

The spinning motor 410 may be spaced in a radial direction from the first axis O1.

The spinning motor 410 may be located on the spinning seating plate 330. The spinning motor 410 may be coupled to the spinning seating plate 330.

The first rotating device 400 may include a first spinning gear 420. The first spinning gear 420 may be a spinning gear connected to the spinning motor 410.

The first spinning gear 420 may be rotated by the spinning motor 410.

The first spinning gear 420 may be coupled to the rotation shaft of the spinning motor 410. While the spinning motor 410 is driven, the first spinning gear 420 may rotate together with the rotation shaft of the spinning motor 410.

The first spinning gear 420 may be a spur gear, although not limited thereto. However, the first spinning gear 420 may be a worm gear. According to the first spinning gear 420 being a worm gear, spinning of the projector module 100 by a user may be limited.

The rotation shaft of the spinning motor 410 may be parallel to the first axis O1. The rotation shaft of the first spinning gear 420 may be parallel to the first axis O1.

The spinning motor 410 may be located on one side of the spinning seating plate 330. The first spinning gear 420 may be located on another side of the spinning seating plate 330, which is opposite to the one side of the spinning seating plate 330. The shaft of the spinning motor 410 may penetrate the spinning seating plate 330.

The spinning motor 410 may be located on a rear side of the spinning seating plate 330. The first spinning gear 420 may be located on a front side of the spinning seating plate 330.

The first spinning gear 420 may have a metal material, although not limited thereto.

The first spinning gear 420 may be manufactured by a milling process, although not limited thereto.

Meanwhile, the first spinning gear 420 may be rotated by the spinning motor 410.

The first rotating device 400 may include a second spinning gear 430. The second spinning gear 430 may be a spinning gear engaged with the first spinning gear 420.

The second spinning gear 430 and the first spinning gear 420 may be located on the same surface of the spinning seating plate 330 such that the second spinning gear 430 is engaged with the first spinning gear 420. The second spinning gear 430 may be located on a lower side of the spinning seating plate 360.

The rotation axis of the second spinning gear 430 may be the same as the first axis O2. While the projector module 100 is spun, the second spinning gear 430 may only perform rotation motion without any translational motion.

The second spinning gear 430 may be coupled to the second part spinning housing 310b. While the second part spinning housing 310b is in contact with the floor, the second part spinning housing 310b may be limited in rotating. While the second part spinning housing 210b is limited in rotating, the second part spinning gear 430 may also be limited in rotating.

While the second spinning gear 430 is limited in rotating, the first spinning gear 420 may perform orbital motion around the second spinning gear 430. The first spinning gear 420 may move around the second spinning gear 430 while rotating about the first axis O1. While the first spinning gear 420 moves around the second spinning gear 430 while rotating about the first axis O1, the spinning motor 410 connected to the first spinning gear 420 may perform orbital motion around the first axis O1. The spinning seating plate 330 coupled to the spinning motor 410 may also perform orbital motion around the first axis O1. The rotating spinning housing 300 coupled to the spinning seating plate 330 may also perform orbital motion around the first axis O1. The projector module 100 coupled to the rotating spinning housing 300 may also perform orbital motion around the first axis O1.

The second spinning gear 430 may have a metal material, although not limited thereto.

The second spinning gear 430 may be manufactured by milling, although not limited thereto.

Meanwhile, the second spinning gear 430 may be engaged with the first spinning gear 420, coupled to the first part spinning housing 310a, and rotate the second part spinning housing 310b about the first axis O1 while the first spinning gear 420 rotates.

The second spinning gear 430 may have a hole at a position corresponding to the rotation axis.

The first rotating device 400 may further include a spinning bearing 440. The spinning bearing 440 may be a component configured to smoothly rotate the second spinning gear 430.

The spinning bearing 440 may be coupled to the second spinning gear 430. The spinning bearing 440 may share the same rotation axis as the second spinning gear 430 and may be coupled to the second spinning gear 430.

The spinning bearing 440 may be accommodated in the hole defined at a center of rotation of the second spinning gear 430. The spinning bearing 440 may be in contact with the second spinning gear 430 at an inner side of the hole in the second spinning gear 430.

The spinning bearing 440 may have substantially the same diameter as the hole in the second spinning gear 430.

The spinning bearing 440 may reduce friction between the second spinning gear 430 and another component being in contact with the spinning bearing 440, while the second spinning gear 430 rotates.

The spinning bearing 440 may be positioned between the second spinning gear 530 and a spinning connector 800 which will be described later. Accordingly, while the spinning connector 800 rotates relative to the second spinning gear 430, a frictional influence of the second spinning gear 430 against the spinning connector 800 may be reduced.

The spinning bearing 440 may be coupled to the spinning seating plate 330. The spinning bearing 440 may be positioned on the spinning seating plate 330. The spinning bearing 440 may be in contact with the spinning seating plate 330. The spinning bearing 440 may be located on the lower side of the spinning seating plate 330.

The spinning bearing 440 may be located between the spinning seating plate 330 and a spinning bearing support 450 which will be described below. Accordingly, the spinning bearing 440 may be prevented from moving in the up-down direction.

The spinning bearing 440 may have a ring shape. The spinning bearing 440 may define a hole at a position corresponding to the first axis O1. The spinning connector 800 which will be described later may be inserted in the hole of the spinning bearing 440.

The spinning bearing 440 may include a ball bearing 440.

The first rotating device 400 may include the spinning bearing support 450. The spinning bearing support 450 may be a component that supports the spinning bearing 440.

The spinning bearing support 450 may be coupled to the spinning seating plate 330. The spinning bearing support 450 may accommodate the spinning bearing 440 between the spinning bearing support 450 and the spinning seating plate 330.

The spinning bearing support 450 may be coupled to the lower side of the spinning seating plate 330.

The spinning bearing support 450 may be located on a front side of the second spinning gear 430.

The spinning bearing support 450 may support the spinning connector 800 which will be described below.

The spinning bearing support 450 may have a ring shape. The spinning bearing support 450 may define a hole at a position corresponding to the first axis O1. The spinning connector 800 may be inserted in the hole of the spinning bearing support 450.

The spinning bearing support 450 may have a plastic material, although not limited thereto.

The spinning bearing support 450 may be formed by injection, although not limited thereto.

The first rotating device 400 may include the fourth wire L4. The fourth wire L4 may be a component that electrically connects the spinning motor 410 to another component.

The fourth wire L4 may be connected to the spinning motor 410.

The fourth wire L4 may be located on the upper side of the spinning seating plate 330.

The video output device 1 may include the spinning connector 800. The spinning connector 800 may be a component that connects wires.

The spinning connector 800 may be inserted in the spinning seating plate 330. A side of the spinning connector 800 may protrude in a rear direction from the spinning seating plate 330. Another side of the spinning connector 800 may protrude in a front direction from the spinning seating plate 330.

The video output device 1 may include the spinning connector 800.

To describe which wire the spinning connector 800 is connected to, an internal electrical connection of the video output device 1 will be described.

The first rotating device 400 may include the spinning motor 410.

The spinning motor 410 may rotate the first spinning gear 420. For example, the spinning motor 410 may rotate the first spinning gear 420 in the counterclockwise direction.

The first spinning gear 420 may rotate the second spinning gear 430 engaged with the first spinning gear 420. The second spinning gear 430 may rotate in an opposite direction of a rotation direction of the first spinning gear 420. For example, while the first spinning gear 420 rotates in the counterclockwise direction, the second spinning gear 430 may rotate in the clockwise direction.

Because the spinning seating plate 330 is coupled to the second spinning gear 430, the spinning seating plate 330 may rotate in the same direction as the second spinning gear 430. For example, while the second spinning gear 430 rotates in the clockwise direction, the spinning seating plate 330 may rotate in the clockwise direction.

Because the first part spinning housing 310a is coupled to the spinning seating plate 330, the first part spinning housing 310a may rotate in the same direction as the spinning seating plate 330. For example, while the spinning seating plate 330 rotates in the clockwise direction, the first part spinning housing 310a may rotate in the clockwise direction.

However, the first part spinning housing 310a may be fixed to the floor. In the case in which the first part spinning housing 310a is fixed to the floor, the spinning seating plate 330 may also be fixed. In the case in which the spinning seating plate 330 is fixed, the second spinning gear 430 may also be fixed.

In the case in which the second spinning gear 430 is fixed, the first spinning gear 420 may move while rotating around the second spinning gear 430. For example, while the first spinning gear 420 rotates in the counterclockwise direction, the first spinning gear 420 may move around the second spinning gear 430 in the counterclockwise direction. That is, the first spinning gear 420 may move in the counterclockwise direction about the first axis O1 along the circumferential direction.

While the first spinning gear 420 moves, the spinning motor 410 coupled to the first spinning gear 420 may move together. For example, while the first spinning gear 420 moves in the counterclockwise direction about the first axis O1 along the circumferential direction, the spinning motor 410 may move in the counterclockwise direction.

While the spinning motor 410 moves, the spinning seating plate 330 coupled to the spinning motor 410 may move together. For example, while the spinning motor 410 moves in the counterclockwise direction about the first axis O1 along the circumferential direction, the spinning seating plate 330 may move in the counterclockwise direction.

While the spinning seating plate 330 moves, the first part spinning housing 310a coupled to the spinning seating plate 330 may move together. For example, while the spinning seating plate 330 moves in the counterclockwise direction about the first axis O1 along the circumferential direction, the rotating housing 240 may move in the counterclockwise direction.

While the rotating housing 240 moves, the projector module 100 coupled to the rotating housing 240 may move together. For example, while the rotating housing 240 moves in the counterclockwise direction about the first axis O1 along the circumferential direction, the projector module 100 may move in the counterclockwise direction.

For example, while the first spinning gear 420 rotates in the counterclockwise direction, the projector module 100 may rotate in the counterclockwise direction about the first axis O1 along the circumferential direction.

While the first spinning gear 420 moves in the clockwise direction, the direction in the above description may be reversed.

The video output device 1 may include the spinning connector 800.

The spinning connector 800 may include a spinning fixed body 810 coupled to the spinning seating plate 330.

The spinning fixed body 810 may rotate together with the spinning seating plate 330. While the spinning seating plate 330 rotates according to the first spinning gear 420, as described above, the spinning fixed body 810 may rotate together.

The spinning fixed body 810 may penetrate the spinning seating plate 330.

The spinning fixed body 810 may penetrate the spinning bearing 440. The spinning fixed body 810 may be positioned between the spinning bearing 440 and the second spinning gear 430. While the spinning fixed body 810 rotates relative to the second spinning gear 430, the spinning bearing 440 may prevent the spinning fixed body 810 from being limited in rotating.

The spinning fixed body 810 may have a cylindrical shape.

The spinning fixed body 810 may include a spinning contact groove 811H. The spinning contact groove 811H may be a groove that is concave inwardly along a circumferential direction of the spinning fixed body 810.

The fourth wire L4 may be accommodated in the spinning contact groove 811H. The spinning contact groove 811H may guide the fourth wire L4 to be located along the spinning contact groove 811H.

While the spinning fixed body 810 rotates by a rotation of the spinning seating plate 330, the fourth wire L4 may be prevented from departing from the spinning contact groove 811H by the spinning contact groove 811H.

The spinning fixed body 810 may include a spinning contact portion 811. The spinning contact portion 811 may be a component which a wire contacts.

The spinning contact portion 811 may be located inside the spinning contact groove 811H.

The spinning contact portion 811 may be located along the circumferential direction of the spinning fixed body 810.

As the fourth wire L4 is accommodated in the spinning contact groove 811H, the fourth wire L4 may contact the spinning contact portion 811. The fourth wire L4 may be in contact with the spinning contact portion 811. While the spinning fixed body 810 rotates, the fourth wire L4 may maintain contact with the spinning contact portion 811.

The spinning contact portion 811 may have a conductor material. Accordingly, the spinning contact portion 811 may be electrically connected to the fourth wire L4.

While the spinning fixed body 810 rotates by a rotation of the spinning seating plate 330, the spinning contact portion 811 may maintain an electrical connection to the fourth wire L4. While the spinning fixed body 810 rotates, the fourth wire L4 may maintain a connection to the spinning contact portion 811 without changing in position.

While the spinning seating plate 330 rotates about the first axis O1, the spinning motor 410 may perform orbital motion around the first axis O1 because the spinning motor 410 is spaced from the first axis O1. The spinning motor 410 may move in a circle around the first axis O1. Because the fourth wire L4 connecting the spinning motor 410 to the spinning connector 800 maintains contact with the spinning contact portion 811 of the spinning fixed body 810 without being coupled to the spinning fixed body 810, the fourth wire L4 may be prevented from being twisted.

The spinning connector 800 may include a spinning rotating body 820. The spinning rotating body 820 may be a component that is rotatable relative to the spinning fixed body 810.

The spinning rotating body 820 may be rotatably coupled to the spinning fixed body 810. The spinning rotating body 820 may be electrically connected to the spinning fixed body 810.

The spinning rotating body 820 may protrude from the spinning fixed body 810 toward the substrate 900.

The video output device 1 may include a fifth wire L5 connecting the spinning rotating body 820 to the connector 700.

The fifth wire L5 may be in contact with the contact portion 711 of the connector 700.

The spinning rotating body 820 may be electrically connected to the firth wire L5.

While the spinning fixed body 810 rotates, the spinning rotating body 820 may be prevented from being influenced by the rotation of the spinning fixed body 810 because the spinning rotating body 820 is rotatably coupled to the spinning fixed body 810. That is, while the spinning fixed body 810 rotates, the spinning rotating body 820 may be limited in rotating.

Because the fifth wire L2 is coupled to the spinning rotating body 820, the fifth wire L5 may be prevented from being twisted while the spinning fixed body 810 rotates.

In other words, because the fifth wire L5 extending from the substrate 900 does not extend along the first axis O1, the fifth wire L5 may be twisted while rotating. However, because the fifth wire L5 is connected to the spinning rotating body 820 of the spinning connector 800 and the spinning rotating body 820 may not rotate although the spinning fixed body 810 rotates, the fifth wire L5 may be prevented from being twisted.

That is, the video output device 1 may include the first rotating device 400, the second rotating device 500, and the third rotating device 600. The first rotating device 400 may rotate at least a portion of the projector module 100 in a first rotation direction or in an opposite direction of the first rotation direction without limitation. The second rotating device 500 may rotate the projector module 100 in a second rotation direction or in an opposite direction of the second rotation direction without limitation. The third rotating device 600 may rotate the projector module 100 in a third rotation direction or in an opposite direction of the third rotation direction without limitation.

Hereinafter, another embodiment than the above-described embodiment will be described. In the following description about the other embodiment, the same components as those shown in FIGS. 1 to 12 may be assigned like reference numerals and descriptions thereof will be omitted.

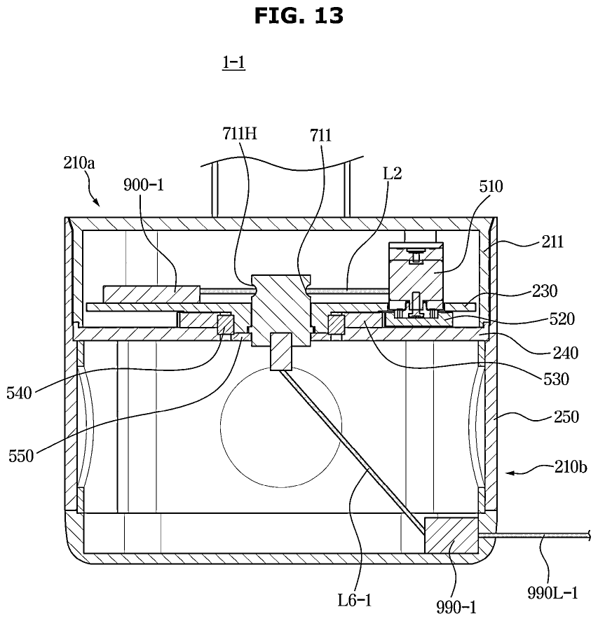

FIG. 13 is a cross-sectional view of a video output device 1-1 according to an embodiment of the present disclosure.

The video output device 1-1 according to an embodiment of the disclosure will be described with reference to FIG. 13.

Unlike the embodiment of FIGS. 1 to 12, a substrate 900-1 may be located on the seating plate 230. The substrate 900-1 and the motor 510 may be located on the same side of the seating plate 230.

A first wire L1-1 connected to the substrate 900-1 may be connected to the fixed body 710 of the connector 700. The first wire L1-1 may be electrically connected to the contact portion 711. The first wire L1-1 may be accommodated in the contact groove 711H.

The video output device 1-1 may include a power terminal 990-1. The power terminal 990-1 may be a component that connects the video output device 1-1 to an external power source.

The power terminal 990-1 may be coupled to the second part housing 210b. The power terminal 990-1 may be able to stably supply power because the second part housing 210b may not move by contacting the floor.

The power terminal 990-1 may be electrically connected to the substrate 900-1. A processor provided on the substrate 900-1 may distribute power obtained from the power terminal 990-1 to the motor 510, etc.

The video output device 1-1 may include a sixth wire L6-1 connecting the power terminal 990-1 to the connector 700.

Meanwhile, the power terminal 990-1 may be configured to receive power from the external power source, and located on the second part housing 210b.

The sixth wire L6-1 may be coupled to the rotating body 720 of the connector 700. The sixth wire L6-1 may not be twisted even when the fixed body 710 rotates.

In other words, although the substrate 900-1 and the motor 510 are positioned on the same side, the connector 700 may be needed in consideration of an electrical connection to the power terminal 990-1.

Meanwhile, the sixth wire L6-1 may be a wire capable of connecting the power terminal 990-1 to the motor 510, and may be connected to the connector 700.

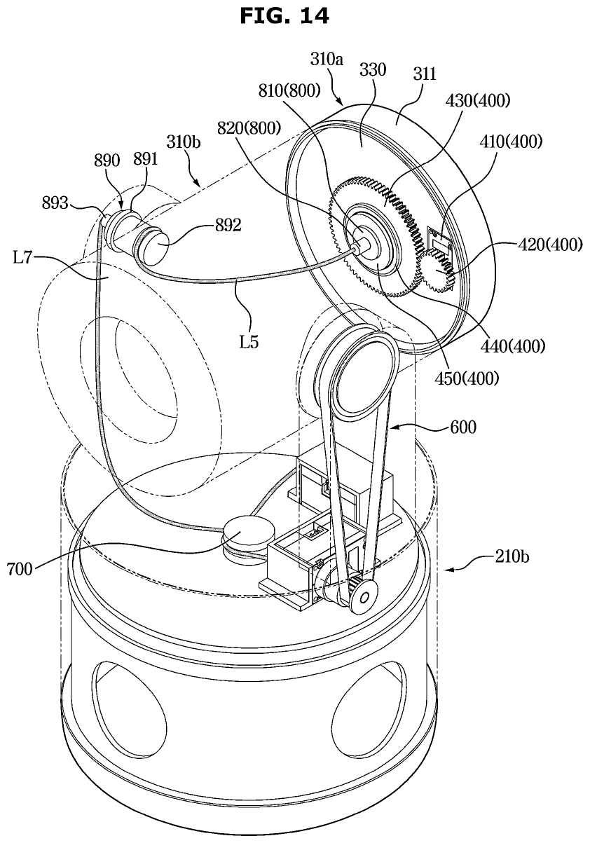

FIG. 14 is a perspective view of a video output device 1-2 according to an embodiment of the present disclosure.

The video output device 1-2 according to an embodiment of the disclosure will be described with reference to FIG. 14.

In the embodiment described with reference to FIGS. 1 to 12, it is difficult to imagine that the projector module 100 is tilted infinitely due to a length of the projector module 100.

In the current embodiment, the following description will be given under an assumption that the projector module 100 is tilted infinitely.

A length of a projector module 100-2 extending along the first axis O1 may be smaller than a distance to the rotating housing 240 on the third axis O3. In this case, the projector module 100 may be tilted infinitely.

In this case, a wire passing between the projector module 100-2 and the side housing 220 may be twisted by a rotation.

The video output device 1 may include a side spinning connector 890, 892. The side spinning connector 890, 892 may be a connector provided in the side housing 220.

The side spinning connector 890-1 may include a side spinning fixed body 891 coupled to the side housing 220, and a side spinning rotating body 893 rotatably coupled to the side spinning fixed body 891.

A fourth wire L4-1 may be a wire connecting the spinning motor 410 to the spinning connector 800. The fourth wire L4-1 may be connected to the spinning fixed body 810 of the spinning connector 800.

A fifth wire L5 may be connected to the spinning rotating body 820 of the spinning connector 800. The fifth wire L5 may be connected to the spinning rotating body 820 and the side spinning fixed body 891 of the side spinning connector 890.

Although the fifth wire L5 moves by tilting of the projector module 100-1, the fifth wire L5 may be electrically connected to the side spinning fixed body 8911.

The video output device 1-1 may include a connection wire L7 connecting a side spinning rotating body 893 to the fixed body 700.

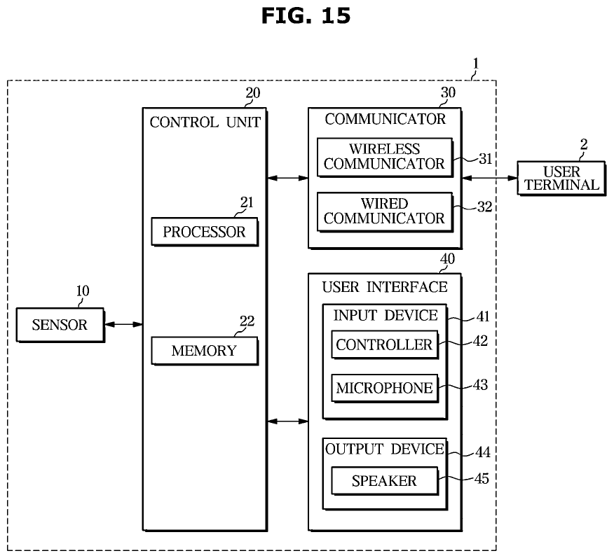

FIG. 15 is a control block diagram according to an embodiment of the present disclosure.

Referring to FIG. 15, the video output device 1 according to an embodiment may include a sensor 10, a control unit 20, a communicator 30, and a user interface 40.

More specifically, the video output device 1 may include the sensor 10 that senses a user's body to obtain user motion data, the communicator 30 including a wireless communicator 31 and a wired communicator 32 for communicating with a user terminal 2, the user interface 40 including an input device 41 to which a user's command is input and an output device 44 that responds to a command, and the control unit 20 electrically connected to the above-described components to control the video output device 1.

The sensor 10 may include a motion sensor capable of sensing motion of a user located in front of the video output device 1. The motion sensor may include a Passive Infrared (PIR) sensor, and the PIR sensor may be a sensor for detecting a human body's movement in a certain area at an acute angle of 9 to 12 degrees through a Fresnel lens. The motion sensor may have any configuration capable of detecting a human body's motion.

The sensor 10 may include a camera capable of photographing a user's body. The camera may obtain a plurality of user body images by photographing the user's body at regular time intervals. The camera may transmit the plurality of user body images to the control unit 20, and the control unit 20 may determine the user's motion based on the plurality of user body images, which will be described below.

The communicator 30 may transmit data to an external device or receive data from an external device based on control by the control unit 20. For example, the communicator 30 may transmit or receive various data by communicating with a server and/or a user terminal 2 and/or a home appliance.

To this end, the communicator 30 may establish a direct (wired) communication channel or a wireless communication channel with an external electronic device (for example, a server, the user terminal 2, and/or a home appliance), and support communication through the established communication channel. According to an embodiment, the communicator 30 may include the wireless communicator 31 (for example, a cellular communication module, a short-range wireless communication module, or a global navigation satellite system (GNSS) communication module), or the wired communicator 32 (for example, a local area network (LAN) communication module or a power line communication module). A corresponding communication module among the communication modules may communicate with an external electronic device through a first network (for example, a short-range communication network, such as Bluetooth, wireless fidelity (WiFi) direct, or infrared data association (IrDA)) or a second network (for example, a telecommunication network, such as a legacy cellular network, a 5G network, a next-generation communication network, internet, or a computer network (for example, a local area network (LAN) or a wide area network (WAN)). Such various kinds of communication modules may be integrated into a component (for example, a single chip) or implemented as a plurality of independent components (for example, a plurality of chips).

According to various embodiments, the communicator 30 may establish communication with the user terminal 2 through a server.

According to various embodiments, the communicator 30 may include a WiFi module, and may perform communication with an external server and/or the user terminal 2 based on communication establishment with an Access Point (AP) in home.

The user interface may be configured with the input device 41 and the output device 44, and provide an interface for interaction between a user and the video output device 1.

The input device 41 may include a controller 42 for remote control of the video output device 1 and a microphone 43 for receiving a user's voice input.

The controller 42 may include a power button, an operation button, a channel and sound selection dial, a voice recognition start button, and a detailed setting button. In addition, the controller 42 may be provided with a tact switch, a push switch, a slide switch, a toggle switch, a micro switch, or a touch switch.

The microphone 43 may start receiving a voice by the voice recognition start button provided in the controller 42. The microphone 43 may receive a user's voice command to obtain an instruction that is to be analyzed by a voice recognition system.

Accordingly, the input device 41 may receive a user input, such as a projection direction of the video output device 1, a channel change, sound adjustment, and a start of voice recognition, and transfer the user input to the control unit 20.

The output device 44 may include a speaker 45 provided inside or outside the video output device 1.

More specifically, the output device 44 may output a notification to the speaker 45 in response to a user's input regarding an operation of the video output device 1, and may further include an external lamp to blink the external lamp in response to the user's input. In addition, the output device 44 may output a sound of content projected from the video output device 1.

The control unit 20 may include a processor 21 that generates a control signal regarding an operation of the video output device 1, and a memory 22 that stores a program, an application, an instruction, and/or data for an operation of the video output device 1. The processor 21 and the memory 22 may be implemented as separate semiconductor devices or may be implemented as a single semiconductor device. In addition, the control unit 20 may include a plurality of processors 21 or a plurality of memories 22. The control unit 20 may be provided at various locations inside the video output device. For example, the control unit 20 may be included in a printed circuit board provided inside a control panel.

The processor 21 may include an arithmetic circuit, a memory circuit, and a control circuit. The processor 21 may include a single chip or a plurality of chips. In addition, the processor 21 may include a single core or a plurality of cores.

The memory 22 may store a program for controlling the video output device 1 according to a user command and data including settings of the video output device 1 according to an input value. In addition, the memory 22 may store current projection direction data based on a user's input of storing a projection direction.

The memory 22 may include a volatile memory, such as Static Random Access Memory (S-RAM) and Dynamic Random Access Memory (D-RAM), and a non-volatile memory, such as Read Only Memory (ROM) and Erasable Programmable Read Only Memory (EPROM). The memory 22 may include a single memory device or a plurality of memory devices.

The processor 21 may process data and/or signals according to a program provided from the memory 22, and provide control signals to individual components of the video output device 1 based on the processed result. For example, the processor 21 may process a user input received through the controller, and the processor 21 may determine whether a projection direction has changed manually by a user.

As another example, the processor 21 may change a projection direction of the projector module 100 to a user-designated projection direction memorized in the memory 22 by using a program provided from the memory 22.

As another example, the processor 21 may recognize a user's movement or change in posture and generate a control signal for driving the motor 510 to align a screen center line with the user's center line.

According to the present disclosure, even though a user arbitrarily changes a projection direction of the projector, the projection direction may be reset based on an original position of the projector module 100 and a memorized position of the projector module 100, thereby preventing a hassle of installing and resetting the video output device 1 according to a projection direction each time.

Also, according to the present disclosure, even though a user moves during screen projection, a projection direction may change to a direction of the user's gaze, thereby enabling the user to optimally view content at any position.

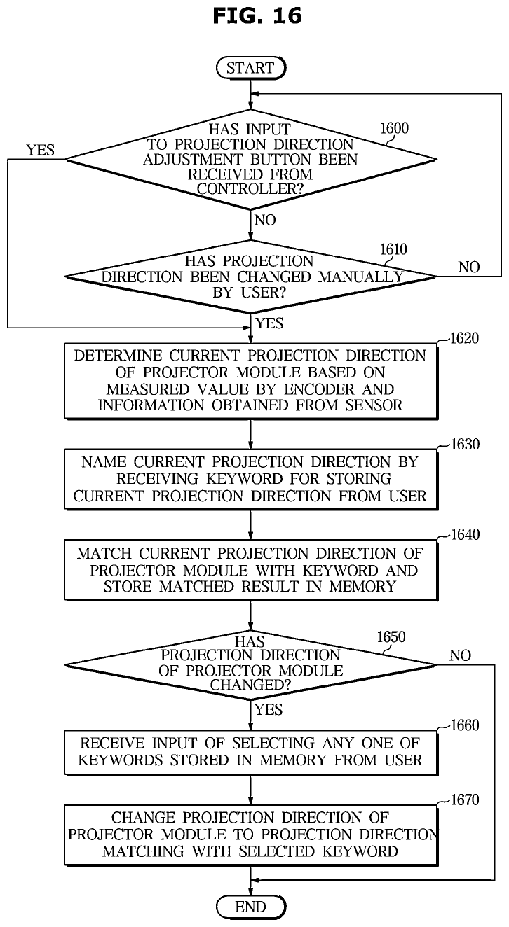

FIG. 16 is a control flow diagram for automatically adjusting a projection direction based on storage of a projection direction according to an embodiment of the present disclosure.

Referring to FIG. 16, the processor 21 may determine whether a user input for changing a projection direction has been received from the controller 42, and more specifically, the processor 21 may determine whether an input to a projection direction adjustment button has been received from the controller 42 (1600). In this case, the user input received by the processor 21 is not limited to a button input of the controller 42, and for example, the user input may include a user input according to voice recognition.

Also, the processor 21 may determine whether a projection direction has been changed manually by a user (1610). For example, a user may change a projection direction to a desired position by operating the projector module 100 with his/her hand, and the projector may determine whether a projection direction has been changed.

Accordingly, based on determination by the processor 21 that an input to the projection button adjustment button has been received from the controller 42 (YES in 1600) or that a projection direction has been changed manually by a user (YES in 1600), the processor 21 may determine a current changed projection direction of the projector module 100.

More specifically, the processor 21 may determine the current projection direction of the video output device 1 based on a measured value by an encoder and an output value of the sensor 10. That is, the processor 21 may determine the current changed projection direction to store the projection direction changed according to the user's command (1620).

Hereinafter, the processor 21 may name the current projection direction by receiving a keyword indicating the current projection direction from a user (1630). For example, the user may name a projection direction that illuminates the ceiling with a text keyword such as “lying down”, and as another example, the user may name a projection direction that illuminates a front side with a numeric keyword such as “1”.

The processor 21 may match the current projection direction of the projector module 100 with the keyword received from the user and store the matched result in the memory 22 (1640).

Hereinafter, the processor 21 may determine whether the projection direction of the projector module 100 has changed (1650), and receive an input of selecting any one of keywords stored in the memory 22 from a user (1660). That is, the user may arbitrarily change the projection direction and then input a keyword to set the projection direction to a projection direction corresponding to the keyword.

The processor 21 may change the projection direction of the projector module 100 to the projection direction matching with the keyword selected by the user, based on reception of the keyword input (1670).

Accordingly, the user may store a projection position by reflecting a projection environment and an individual's preference, and change a projection direction through a simple keyword, which increases convenience and enables intuitive control.

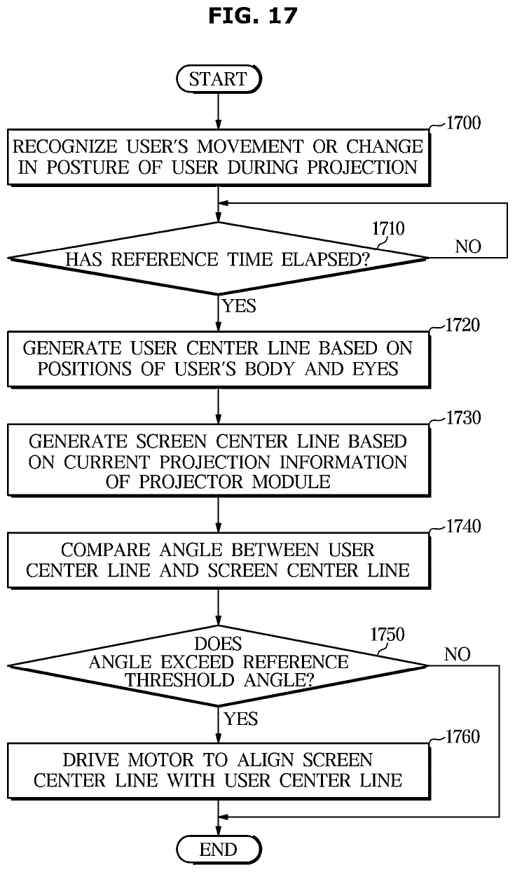

FIG. 17 is a control flow diagram for automatically adjusting a projection direction based on detection of a user position according to an embodiment of the present disclosure.

Referring to FIG. 17, the processor 21 may recognize a user's movement or change in posture while projecting content (1700). As described above, the motion sensor may detect a user's motion, and the camera may determine a user's motion from a plurality of user body images.

The processor 21 may determine whether a preset reference time has elapsed after the processor 21 recognizes the user's movement or motion (1710). According to elapse of the preset reference time after the processor 21 recognizes the user's movement or motion (YES in 1710), the processor 21 may generate a user center line based on positions of the user's body and eyes (1720). At this time, the processor 21 may obtain an image for generating the user center line by transmitting a control signal to the sensor 10.

More specifically, the processor 21 may obtain the positions of the user's eyes and upper body by analyzing the obtained image using an image processing technique. Also, the processor 21 may obtain a center point of the user's body based on the positions of the user's eyes and upper body, and generate a center line connecting the center point to an end point in a direction in which the user's body faces.

The processor 21 may generate a screen center line based on current projection information of the projector module 100 (1730). More specifically, the processor 21 may determine a direction in which the projector module 100 currently projects the content based on a measured value by the encoder and information obtained from the sensor.

Also, because a current position of the video output device 1 has been stored in the memory 22, the processor 21 may obtain the screen center line connecting the current position of the projector module 100 to a projection surface.

Thereafter, the processor 21 may compare an angle between the user center line and the screen center line (1740). That is, the processor 21 may compare an angle between a direction in which the user looks the projection surface and a direction in which the projector module 100 looks the projection surface.

The processor 21 may determine whether the angle between the user center line and the screen center line exceeds a preset reference threshold angle (1750).

According to the angle between the user center line and the screen center line not exceeding the reference threshold angle, the processor 21 may terminate control without driving the motor 51 (1760), and according to the angle between the user center line and the screen center line not exceeding the reference threshold angle, the processor 21 may not change a projection direction of the projector module 100.

That is, according to the present disclosure, while a user temporarily moves his/her body or moves to an extent that does not cause discomfort in viewing content, the projection direction of the projector module 100 may not change, thereby increasing stability in viewing content.

Meanwhile, according to the angle between the user center line and the screen center line exceeding the reference threshold angle, the processor 21 may drive the motor 510 to align the screen center line with the user center line (1760).

Because the video output device 1 according to the present disclosure includes the connector 700, the video output device 1 may prevent the wires from being twisted even when controlling the motor 510 according to the control method described above with reference to FIGS. 16 and 17. That is, even when the processor 21 receives a command from a user and performs tilting, panning, or spinning according to a program stored in the memory 22, the processor 21 may enable infinite rotations without twisting of the wires.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

The computer-readable recording medium may be provided in the form of a non-transitory storage medium, wherein the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store (e.g., Play Store™) or between two user devices (e.g., smart phones) directly. When distributed online, at least a part of the computer program product (e.g., a downloadable app) may be temporarily generated or at least temporarily stored in the machine-readable storage medium, such as a memory of the manufacturer's server, a server of the application store, or a relay server.

So far, specific embodiments have been shown and described. However, the disclosure is not limited to the above-described embodiments, and various modifications can be made by one of ordinary skill in the technical field to which the disclosure belongs without departing from the gist of the technical idea of the disclosure defined by the claims below.

1. A video output device comprising:
a projector module configured to output a content image along a radiation direction;
a first rotating device configured to rotate at least a portion of the projector module about a first axis that is parallel to the radiation direction;
a second rotating device configured to rotate the projector module about a second axis intersecting the first axis;
a substrate electrically connected to the second rotating device; and
a connector electrically connected to the substrate through a first wire, and electrically connected to the second rotating device through a second wire,
wherein, while the projector module rotates about the second axis, the connector is configured to prevent the first wire and the second wire from being twisted.

2. The video output device of claim 1, further comprising a third rotating device configured to rotate the projector module about a third axis intersecting the first axis and the second axis.

3. The video output device of claim 2, wherein
the first rotating device is configured to rotate the at least the portion of the projector module in a first rotation direction or in an opposite direction of the first rotation direction without limitation,
the second rotating device is configured to rotate the projector module in a second rotation direction or in an opposite direction of the second rotation direction without limitation, and
the third rotating device is configured to rotate the projector module in a third rotation direction or in an opposite direction of the third rotation direction without limitation.

4. The video output device of claim 2, further comprising
a first part housing coupled to the projector module; and
a second part housing rotatably coupled to the first part housing,
wherein the second rotating device rotates the projector module about the second axis by rotating the first part housing relative to the second part housing.

5. The video output device of claim 4, wherein
the second part housing comprises:
a support plate configured to rotatably support the first part housing; and
a cover housing configured to accommodate the support plate and at least a portion of the first part housing and be rotatable together with the support plate.

6. The video output device of claim 4, wherein
the second rotating device comprises:
a motor;
a first gear being rotatable by the motor; and
a second gear, to be engaged with the first gear, configured to rotate about the second axis as a rotation axis, and coupled to the second part housing.

7. The video output device of claim 6, wherein
the motor is spaced from the second axis to perform orbital motion around the second axis while the first part housing rotates, and
the connector is configured to prevent the second wire connected to the motor from moving and maintain an electrical connection.

8. The video output device of claim 4, wherein
the substrate is accommodated in the second part housing and
the connector is configured to prevent the first wire connected to the substrate from being twisted and maintain an electrical connection.

9. The video output device of claim 4, wherein
the connector comprises a fixed body including an accommodating groove configured to accommodate the second wire connected to the second rotating device and a terminal configured to contact the first wire in the accommodating groove, the fixed body being coupled to the first part housing,
wherein the terminal rotates about the second axis together with the projector module and maintains contact with the first wire, while the projector module rotates about the second axis.

10. The video output device of claim 4, wherein
the connector comprises:
a fixed body configured to be coupled to the first part housing; and
a rotating body connected to the first wire connected to the substrate and configured to be coupled to the fixed body in such a way as to rotate relative to the fixed body,
wherein the rotating body is configured to allow the first wire to rotate about the second axis as a rotation axis while the projector module rotates about the second axis.

11. The video output device of claim 6, wherein
the first part housing comprises:
a seating plate configured such that the motor is located on one side of the seating plate and the substrate faces another side of the seating plate which is opposite to the one side; and
a rotating housing coupled to the seating plate and configured to rotate together with the seating plate,
wherein the connector penetrates the seating plate.

12. The video output device of claim 11, wherein
the second part housing comprises a support plate configured to face the seating plate,
the second gear is coupled to the support plate between the support plate and the seating plate, and
the second rotating device comprises a bearing positioned between the second gear and the seating plate and configured to be rotatable relative to the second gear.

13. The video output device of claim 11, wherein
the projector module comprises:
a first part spinning housing; and
a second part spinning housing rotatably coupled to the first part spinning housing,
wherein the first rotating device comprises
a spinning motor coupled to the first part spinning housing;
a first spinning gear configured to be rotatable by the spinning motor; and
a second spinning gear engaged with the first spinning gear, coupled to the first part spinning housing, and configured to rotate the second part spinning housing about the first axis while the first spinning gear rotates.

14. The video output device of claim 12, wherein
the third rotating device comprises:
a tilting motor configured to be supported by the support plate;
a first pulley coupled to a tiling motor and configured to be rotated by the tiling motor;
a second pulley coupled to the projector module; and
a rail coupled to the first pulley and the second pulley such that the projector module rotates according to a rotation of the first pulley.

15. The video output device of claim 6. comprising:
a power terminal configured to receive power from an external source and located on the second part housing; and
a third wire configured to connect the power terminal to the motor and connected to the connector.
